(19) United States
(12) Patent Application Publication
(10) Pub. No.: US 2011/0109817 A1
(43) Pub. Date: May 12, 2011

(54) Display device, method of driving the same, and electronic unit

(75) Inventors: Naobumi Toyomura, Kanagawa (JP); Katsuhide Uchino, Kanagawa (JP)

(73) Assignee: Sony Corporation, Tokyo (JP)

(21) Appl. No.: 12/923,979

(22) Filed: Oct. 19, 2010

(30) Foreign Application Priority Data
Nov. 11, 2009 (JP) 2009-258317

(51) Int. Cl. H04N 5/70; G09G 5/00

(52) U.S. Cl. 348/800; 345/212; 348/E05.135

(57) ABSTRACT

A display device includes: pixels each including a light emitting element; scan lines, signal lines, and power supply lines; a scan line drive circuit applying a selection pulse to the scan lines in succession; a signal line drive circuit applying a signal pulse to the signal lines through switching a gray-scale interpolation voltage, a basic voltage and a video signal voltage, in this order to perform gray-scale interpolation; and a power supply line drive circuit applying a control pulse to the power supply lines. The scan line drive circuit generates the selection pulse through alternately switching an on-voltage and an off-voltage, and applies the pulse to the scan lines so that application of the on-voltage to the scan line starts in a time period of the gray-scale interpolation voltage and the on-voltage is switched to the off-voltage in a time period of the basic voltage.

### BACKGROUND OF THE INVENTION

1. Field of the Invention

The present invention relates to a display device using a self light emitting element such as an organic EL (Electro Luminescence) element, a method of driving the same, and an electronic unit having such a display device.

2. Description of the Related Art

In recent years, in the field of a display device for displaying an image, a display device (organic EL display device) using, as a light emitting element, an optical element of a current driving type whose light emission luminance level changes according to the value of a flowing current, for example, an organic EL element, is developed and is being commercialized.

An organic EL element is a self light emitting element different from a liquid crystal element or the like. Consequently, in an organic EL display device, a light source (backlight) is unnecessary. As compared with a liquid crystal display device requiring a light source, visibility of an image is higher, power consumption is lower, and response of the element is faster.

As driving methods of an organic EL display device, like driving methods of a liquid crystal display device, there are a simple (passive) matrix method and an active matrix method. The former method has, although the structure is simple, a problem such that it is difficult to realize a large-size and high-resolution display device. Consequently, at present, an active matrix method as the latter method is actively developed. In the method, current flowing in organic EL elements disposed for pixels is controlled by an active element (generally, TFT (Thin Film Transistor)) provided in a drive circuit provided for each of the organic EL elements.

It is generally known that the current-voltage (I-V) characteristic of an organic EL element deteriorates with lapse of time. In a pixel circuit for current-driving an organic EL element, when the I-V characteristic of the organic EL element changes with time, the value of current flowing in a drive transistor changes. Consequently, the value of current flowing in the organic EL element itself also changes, and the light emission luminance level also changes accordingly.

There is a case that a threshold voltage Vth and mobility μ of the drive transistor change with time, or vary among pixels due to variations in manufacturing processes. In the case where the threshold voltage Vth or mobility μ varies among pixels, the value of current flowing in the drive transistor varies among pixels. Consequently, even when the same voltage is applied to the gate of the drive transistor, the light emission luminance level of the organic EL element varies, and uniformity of a screen deteriorates.

There is consequently a proposal for maintaining the light emission luminance level of an organic EL element constant even when the I-V characteristic of an organic EL element changes with time, a threshold voltage Vth or mobility μ of a drive transistor changes with time or varies among pixels without being influenced by the variations. Concretely, a display device is proposed, having both a function of compensating fluctuations in the I-V characteristic of an organic EL element and a function of correcting fluctuations in the threshold voltage Vth or mobility μ of a drive transistor (refer to, for example, Japanese Unexamined Patent Application Publication No. 2008-33193).

### SUMMARY OF THE INVENTION

At present, in the market of flat panel displays, the share of a liquid crystal television using a liquid crystal display device is increasing. A lower price as well as a larger and thinner screen promotes the willingness of consumers. Therefore, to promote sales of organic EL televisions each using an organic EL display device, it is important to realize lower price (lower cost).

As a measure, for example, cost reduction in a periphery circuit for driving pixels is considered. The periphery circuit includes a data driver for supplying a video signal to each of pixels. The number of output gray-scale levels of the data driver is often set to 10-bit gray-scale (1,024 gray-scale levels). If the number of output gray-scale levels is reduced, the cost is lowered. However, in the case of simply reducing the number of output gray-scale levels, the display picture quality deteriorates.

To address the deterioration, by reducing the number of output gray-scale levels of the data driver to, for example, 8-bit gray-scale (256 gray-scale levels) and interpolating gray-scale in the 8-bit gray-scale by, for example, two bits (four gray-scale levels), the expression is finally increased to 10-bit gray-scale.

Concretely, by applying a signal voltage for predetermined gray-scale interpolation (hereinbelow, simply called gray-scale interpolation voltage) prior to application of video signal voltage to pixels, the gray-scale interpolation is performed. Specifically, the gray-scale interpolation voltage for the video signal voltage is varied over a plurality of voltage values, and the gray-scale interpolation of the video signal voltage is performed with the voltage values of the gray-scale interpolation voltage. In the following, a two-step driving method of performing pixel driving by applying the gray-scale interpolation voltage and then applying the video signal voltage will be described.

However, in the two-step driving method, since the gray-scale interpolation voltage has to be varied over a plurality of voltage values for one voltage value of the video signal voltage, the range of the voltage value which is changed in the gray-scale interpolation voltage tends to vary depending on the voltage value of the video signal voltage. When the voltage value range in the gray-scale interpolation voltage varies in each of the voltage values of the video signal voltage, a memory has to be provided excessively in the periphery circuit, and it causes increase in cost.

It is therefore desirable to provide a display device realizing higher picture quality while reducing cost, a method of driving the same, and electronic unit.

Each of first to fourth display devices as embodiments of the present invention includes: a plurality of pixels each including a light emitting element; scan lines, signal lines, and power supply lines each connected to some of the plurality of the pixels; a scan line drive circuit applying a selection pulse to each of the scan lines in succession, the selection pulse allowing a row of pixels to be selected from the plurality of pixels; a signal line drive circuit applying a signal pulse to each of the signal lines through switching a gray-scale interpolation voltage, a basic voltage, and an originally provided video signal voltage, in this order, and varying the gray-scale interpolation voltage over a plurality of voltage values, thereby performing gray-scale interpolation on light emission luminance level for each of the light emitting elements; and a power supply line drive circuit applying a control pulse to each of the power supply lines, the control pulse allowing the light emitting element to be on and off.

In the first display device, the scan line drive circuit generates the selection pulse through alternately switching an on-voltage and an off-voltage, and applies the generated selection pulse to each of the scan lines so that application of the on-voltage to the scan line starts in a time period of the gray-scale interpolation voltage and the on-voltage is switched to the off-voltage in a time period of the basic voltage.

In the second display device, the scan line drive circuit generates the selection pulse through alternately switching an on-voltage and an off-voltage and applies the generated selection pulse to each of the scan lines, so that a first on-voltage is applied in a time period of the video signal voltage, and a second on-voltage lower than the first on-voltage is applied in a time period of the gray-scale interpolation voltage.

In the third display device, the control pulse is generated through alternately switching a higher power supply voltage and a lower power supply voltage, and a first voltage and a second voltage lower than the first voltage are provided as the higher power supply voltage. The first voltage is applied to the power supply line during application of the video signal voltage, and the second voltage is applied to the power supply line during application of the gray-scale interpolation voltage

In the fourth display device, the signal line drive circuit has a conversion circuit. The conversion circuit converts an input video signal which is a digital signal into the gray-scale interpolation voltage and the video signal voltage which are analog signals, in such a manner that a dynamic range of the gray-scale interpolation voltage is narrower than that of the video signal voltage.

Electronic unit as an embodiment of the invention has any of the first to fourth display devices.

Methods of driving the first to fourth display devices as embodiments of the present invention include the steps of: at the time of performing display driving on a plurality of pixels each including a light emitting element and to which scan lines, signal lines, and power supply lines are connected, applying a selection pulse to each of the scan lines in succession, the selection pulse allowing a row of pixels to be selected from the plurality of pixels; applying a signal pulse to each of the signal lines through switching a gray-scale interpolation voltage, a basic voltage and an originally provided video signal voltage, in this order; applying a control pulse to each of the power supply lines, the control pulse allowing the light emitting element to be on and off; and varying the gray-scale interpolation voltage over a plurality of voltage values, thereby performing gray-scale interpolation on a light emission luminance level for each of the light emitting elements.

In the method of driving the first display device, the selection pulse is generated through alternately switching an on-voltage and an off-voltage, and the generated selection pulse is applied to each of the scan lines so that application of the on-voltage to the scan line starts in a time period of the gray-scale interpolation voltage and the on-voltage is switched to the off-voltage in a time period of the basic voltage.

In the method of driving the second display device, a control is performed so that the selection pulse rises up from the off-voltage to a first on-voltage and then falls down from the first on-voltage to the off-voltage, in a time period of the video signal voltage, and the selection pulse rises up from the off-voltage to a second on-voltage, which is lower than the first on-voltage, in a time period of the gray-scale interpolation voltage, and then falls down from the second on-voltage to the off-voltage in a time period of the basic voltage.

In the method of driving the third display device, the control pulse is applied to each of the power supply lines through alternately switching a higher power supply voltage and a lower power supply voltage, and through applying the switched power supply voltage to the power supply line, the higher power supply voltage including a first voltage and a second voltage lower than the first voltage. The first voltage is applied to the power supply line during application of the video signal voltage, and the second voltage is applied to the power supply line during application of the gray-scale interpolation voltage.

In the method of driving the fourth display device, an input video signal which is a digital signal is converted into the gray-scale interpolation voltage and the video signal voltage which are analog signals, in such a manner that a dynamic range of the gray-scale interpolation voltage is narrower than that of the video signal voltage.

In the first display device and the method of driving the same out of the first to fourth display devices and the methods of driving the same as embodiments of the invention, the on-voltage is applied to the scan line within a period of applying the gray-scale interpolation voltage to the signal line, and switching from the on-voltage to the off-voltage is performed within a period of applying the basic voltage to the signal line. In such a manner, as compared with the case of performing the switching from the on-voltage to the off-voltage within the period of applying the gray-scale interpolation voltage, in a period after application of the gray-scale interpolation voltage to start of application of the video signal (basic voltage application period), the bootstrap operation is suppressed or prevented. As a result, the mobility correction amount after application of the gray-scale interpolation voltage becomes smaller, and a change in the current (current to drive the light emitting element) accompanying the rise in the gray-scale interpolation voltage decreases. In other words, the mobility correction amount decreases, and the tilt of the current change characteristic with respect to the gray-scale interpolation voltage becomes gentle.

In the second display device and the method of driving the same, to the scan line, a first on-voltage is applied at the time of applying the video signal voltage, and a second on-voltage lower than the first on-voltage is applied at the time of applying the gray-scale interpolation voltage. As a result, the mobility correction amount decreases, and the tilt of the current change characteristic with respect to the gray-scale interpolation voltage becomes gentle.

In the third display device and the method of driving the same, at the time of applying the gray-scale interpolation voltage to the signal line, out of a first high power supply voltage and a second high power supply voltage (<first high power supply voltage) which may be selectively applied, the second high power supply voltage is applied to the power supply line. By the operation, the mobility correction amount decreases, and the tilt of the current change characteristic of the gray-scale interpolation voltage becomes gentle.

In the fourth display device and the method of driving the same, at the time of converting digital input video signals to analog signals, a dynamic range of the gray-scale interpolation voltage is made smaller than that of the video signal voltage. By the operation, the tilt of the current change characteristic of the gray-scale interpolation voltage becomes gentle.

In the first to fourth display devices, the methods for driving the same, and the electronic unit as embodiments of the present invention, at the time of performing display driving on a plurality of pixels, a predetermined selection pulse is applied to a scan line, the gray-scale interpolation voltage, the basic voltage, and the video signal voltage are applied in this order to the signal line, a predetermined control pulse is applied to the power supply line, and a predetermined operation is performed at the time of applying the voltage pulses to the scan line, the signal line, or the power supply line or at the time of converting digital input video signals to analog signals. Therefore, the tilt of the current change characteristic for the gray-scale interpolation voltage is made gentle. As a result, at the time of making the gray-scale interpolation voltage applied to the signal line vary to a plurality of voltage values and interpolating gray-scale of the light emission luminance level, the voltage values of the gray-scale interpolation voltage are set in almost the same range at all of tones of the video signal voltage. Consequently, without providing an extra memory in a periphery circuit such as a data driver (a signal line drive circuit), gray-scale interpolation is performed, and the number of gray-scale levels expressed is increased. Therefore, while reducing the cost, higher picture quality is realized.

Other and further objects, features and advantages of the invention will appear more fully from the following description.

### BRIEF DESCRIPTION OF THE DRAWINGS

FIG. 1 is a configuration diagram illustrating an example of a display device according to first to fifth embodiments of the present invention.

FIG. 2 is a circuit diagram illustrating an example of an internal configuration of a pixel in FIG. 1.

FIG. 3 is a timing waveform chart illustrating an example of display drive operation according to the first embodiment.

FIG. 4 is a timing waveform chart for explaining changes in gate potential and source potential of a drive transistor when gray-scale interpolation voltage is changed in gray-scale interpolation writing operation illustrated in FIG. 3.

FIG. 5 is a timing waveform chart for explaining the details of the writing operation with a gray-scale interpolation voltage and a video signal voltage in example 1 and comparative example.

FIG. 6 is a characteristic diagram illustrating an example of the relation (the current change characteristic of the gray-scale interpolation voltage) between the gray-scale interpolation voltage and current (light emission luminance level) flowing in the drive transistor in the example 1 and the comparative example.

FIGS. 7A and 7B are characteristic diagrams for explaining the gray-scale interpolation operation in the comparative example.

FIGS. 8A and 8B are characteristic diagrams for explaining the gray-scale interpolation operation in the example 1.

FIG. 9 is a timing waveform chart illustrating an example of display drive operation according to the second embodiment.

FIG. 10 is a timing waveform chart for explaining changes in the gate potential and source potential of a drive transistor when gray-scale interpolation voltage is changed in gray-scale interpolation writing operation illustrated in FIG. 9.

FIG. 11 is a diagram for explaining action in the gray-scale interpolation writing operation illustrated in FIG. 9.

FIG. 12 is a timing waveform chart illustrating an example of display drive operation according to the third embodiment.

FIG. 13 is a timing waveform chart for explaining the details of operation of writing the gray-scale interpolation voltage and the video signal voltage in the examples 1 and 2.

FIG. 14 is a timing waveform chart illustrating an example of display drive operation according to the fourth embodiment.

FIG. 15 is a timing waveform chart for explaining the details of operation of writing the gray-scale interpolation voltage and the video signal voltage in the examples 1 and 3.

FIG. 16 is a circuit diagram illustrating an example of a signal line drive circuit according to the fifth embodiment.

FIG. 17 is a characteristic diagram illustrating an example of the relation (the current change characteristic of the gray-scale interpolation voltage) between the gray-scale interpolation voltage and current (light emission luminance level) flowing in a drive transistor in the examples 4 and 5.

FIG. 18 is a plan view illustrating a schematic configuration of a module including the display device illustrated in FIG. 1.

FIG. 19 is a perspective view illustrating the appearance of application example 1 of the display device illustrated in FIG. 1.

FIG. 20A is a perspective view illustrating the appearance seen from the front side of the application example 2, and FIG. 20B is a perspective view illustrating the appearance seen from the back side.

FIG. 21 is a perspective view illustrating the appearance of the application example 3.

FIG. 22 is a perspective view illustrating the appearance of the application example 4.

FIG. 23A is a front view in an open state of application example 5, FIG. 23B is a side view in the open state, FIG. 23C is a front view in a closed state, FIG. 23D is a left side view, FIG. 23E is a right side view, FIG. 23F is a top view, and FIG. 23G is a bottom view.

### DETAILED DESCRIPTION OF THE PREFERRED EMBODIMENTS

Embodiments of the present invention will be described in detail hereinbelow with reference to the drawings. The description will be given in the following order.

1. Configuration of display device
2. First embodiment (example of switching from on-voltage of scan line voltage to off-voltage at the time of applying gray-scale interpolation voltage within a basic voltage writing period)
3. Second embodiment (example of setting the gray-scale interpolation voltage to a voltage value lower than the basic voltage)
4. Third embodiment (example of varying the scan line voltage over three values (Von1, Von2, and Voff), using the voltage Von1 at the time of applying the video signal voltage, and using the voltage Von2 (<Von1) at the time of applying the gray-scale interpolation voltage)
5. Fourth embodiment (example of varying power supply voltage over three values (Vcc1, Vcc2, and Vini), using the voltage Vcc1 at the time of applying the video signal voltage, and using the voltage Vcc2 (<Vcc1) at the time of applying the gray-scale interpolation voltage
6. Fifth embodiment (example of performing D/A conversion while setting a dynamic range of the gray-scale interpolation voltage to be smaller than that of the video signal voltage)
7. Module and application examples

Configuration of Display Device 1

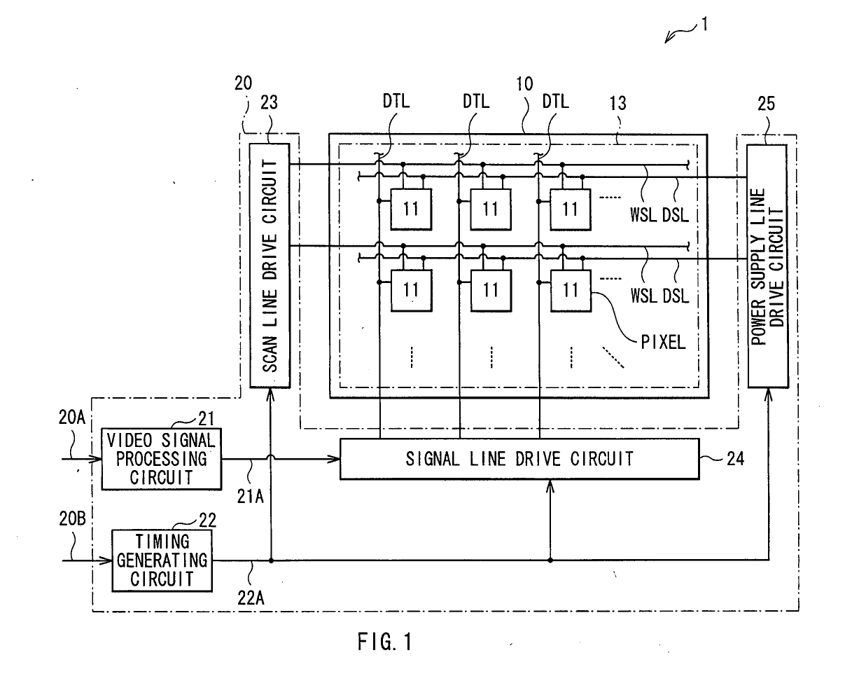

FIG. 1 is a block diagram illustrating a schematic configuration of a display device (display device 1) according to first to fifth embodiments of the present invention to be described below. The display device 1 has a display panel 10 (display section) and a drive circuit 20.

Display Panel 10

The display section 10 has a pixel array 13 in which a plurality of pixels 11 are arranged in a matrix, and displays an image by active matrix driving on the basis of a video signal 20A and a synchronization signal 20B input from the outside. Each pixel 11 is any of pixels of three primary colors of red (R), green (G), and blue (B), and includes an organic electric field light emitting element that generates color light.

The pixel array 13 also has a plurality of scan lines WSL disposed in rows, a plurality of signal lines DTL disposed in columns, and a plurality of power supply lines DSL disposed in rows along the scan lines WSL. One end of each of the scan lines WSL, the signal lines DTL, and the power supply lines DSL is connected to the drive circuit 20 which will be described later. The pixels 11 are disposed in matrix in correspondence with intersections of the scan lines WSL and the signal lines DTL.

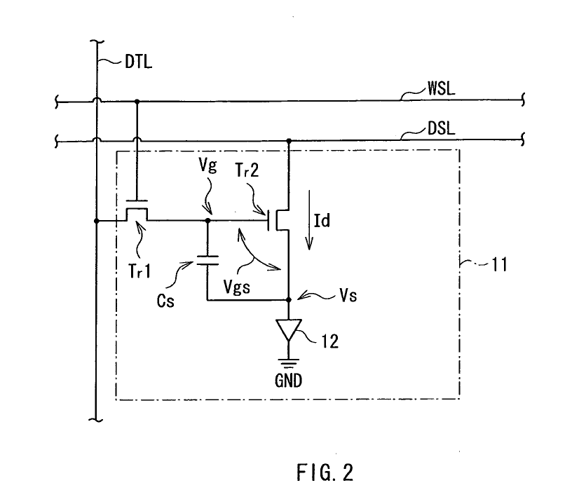

FIG. 2 illustrates an example of the circuit configuration in the pixel 11. The pixel 11 has a circuit configuration of so-called “2Tr1C” and includes an organic EL element 12 (light emitting element), a write (sampling) transistor Tr1 (first transistor), a drive transistor Tr2 (second transistor), and a retention capacitor Cs. Each of the write transistor Tr1 and the drive transistor Tr2 is, for example, an n-channel MOS (Metal Oxide Semiconductor)-type TFT. The kind of the TFT is not particularly limited and may be of, for example, an inverted staggered structure (so-called bottom gate type) or a staggered structure (so-called top gate type).

In the pixel 11, the gate of the write transistor Tr1 is connected to the scan line WSL, the drain is connected to the signal line DTL, and the source is connected to the gate of the drive transistor Tr2 and one end of the retention capacitor Cs. The drain of the drive transistor Tr2 is connected to the power supply line DSL, and the source is connected to the other end of the retention capacitor Cs and the anode of the organic EL element 12. The cathode of the organic EL element 12 is set to a fixed potential and, in this case, connected to a ground line GND, thereby being set to the ground (ground potential). The cathode of the organic EL element 12 functions as a common electrode of the organic EL elements 12 and is, for example, formed continuously along the entire display region of the display panel 10 and formed as a plate-shaped electrode.

Drive Circuit 20

The drive circuit 20 performs display driving of the pixel array 13 (display panel 10). Concretely, as the details will be described later, while sequentially selecting the plurality of pixels 11 in the pixel array 13, by applying a video signal voltage based on the video signal 20A to the selected pixels 11, the drive circuit 20 performs display driving of the plurality of pixels 11. As illustrated in FIG. 1, the drive circuit 20 has a video signal processing circuit 21, a timing generating circuit 22, a scan line drive circuit 23, a signal line drive circuit 24, and a power supply line drive circuit 25.

The video signal processing circuit 21 performs predetermined correction on the digital video signal 20A input from the outside and outputs the corrected video signal 21A to the signal line drive circuit 24. The predetermined correction is gamma correction, overdrive correction, or the like.

The timing generating circuit 22 generates a control signal 22A on the basis of the synchronization signal 20B input from the outside and outputs the control signal 22A, thereby performing control so that the scan line drive circuit 23, the signal line drive circuit 24, and the power supply line drive circuit 25 operate interlockingly.

The scan line drive circuit 23 sequentially applies a selection pulse (scan line voltage) to the plurality of scan lines WSL in accordance with the control signal 22A, thereby sequentially selecting the plurality of pixels 11. Concretely, a voltage Von for setting the write transistor Tr1 to the on-state and a voltage Voff for setting the write transistor Tr1 to the off-state are alternately (periodically) switched and output as a selection pulse. The voltage Von has a value (constant value) equal to or larger than the on-voltage of the write transistor Tr1, and the voltage Voff has a value (constant value) lower than the on-voltage of the write transistor Tr1. The voltages Von and Voff correspond to examples of the “on-voltage” and “off-voltage” in the present invention.

The signal line drive circuit 24 generates an analog video signal corresponding to the video signal which is input from the video signal processing circuit 21 in accordance with the control signal 22A, and applies the analog video signal to the signal lines DTL. Concretely, by applying an analog signal voltage based on the video signal 20A to each of the signal lines DTL, the signal line drive circuit 24 writes a video signal in the pixel 11 (to be selected) selected by the scan line drive circuit 23. Writing of a video signal denotes application of predetermined voltage across the gate and the source of the drive transistor Tr2.

The signal line drive circuit 24 outputs, as signal pulses (signal line voltages), three voltages; a gray-scale interpolation voltage Vsig1 as a signal voltage for gray-scale interpolation, a signal voltage Vofs (basic voltage), and a video signal voltage Vsig2 as a signal voltage based on the video signal 20A while switching the signals in this order. For example, the signal line drive circuit 24 applies the voltage Vofs, the gray-scale interpolation voltage Vsig1, the voltage Vofs, and the video signal voltage Vsig2 in this order to the signal lines DTL in one horizontal (1H) period. The voltage Vofs is a voltage to be applied to the gate of the drive transistor Tr2 when the organic EL element 12 is off. Concretely, when threshold voltage of the drive transistor Tr2 is Vth, the voltage Vofs is set so that (Vofs−Vth) becomes a voltage value lower than a voltage value (Vel+Vca) obtained by adding a threshold voltage Vel in the organic EL element 12 and a cathode voltage Vca.

As the details will be described later, such a signal line drive circuit 24 performs the gray-scale interpolation of light emission luminance level by varying the gray-scale interpolation voltage Vsig1 over a plurality of voltage values.

The power supply line drive circuit 25 sequentially applies a control pulse (power supply line voltage) to the plurality of power supply lines DSL in accordance with the control signal 22A, thereby controlling the light-on operation and the light-off operation on each of the organic EL elements 12. Concretely, a voltage Vcc for passing current Id to the drive transistor Tr2 and a voltage Vini for not passing the current Id to the drive transistor Tr2 are alternately (periodically) switched and output as a control pulse. The voltage Vini is set so as to have a voltage value (constant value) lower than a voltage value (Vel+Vca) obtained by adding the threshold voltage Vel and the cathode voltage Vca in the organic EL element 12. The voltage Vcc is set to have a voltage value (constant value) equal to or larger than the voltage value (Vel+Vca). The voltage Vcc corresponds to an example of “high power-supply voltage” of the invention, and the voltage Vini corresponds to an example of “low power-supply voltage” of the invention.

The operation of the display device 1 will now be described by first to fifth embodiments.

### First Embodiment

### 1. Display Drive Operation

In the display device 1, as illustrated in FIGS. 1 and 2, the drive circuit 20 performs display driving on the pixels 11 in the display panel 10 (pixel array 13) on the basis of the video signal 20A and the synchronization signal 20B. By the display driving, drive current is injected into the organic EL element 12 in each of the pixels 11, holes and electrons are recombined, and light emission occurs. The generated light is taken to the outside and an image is displayed on the display panel 10.

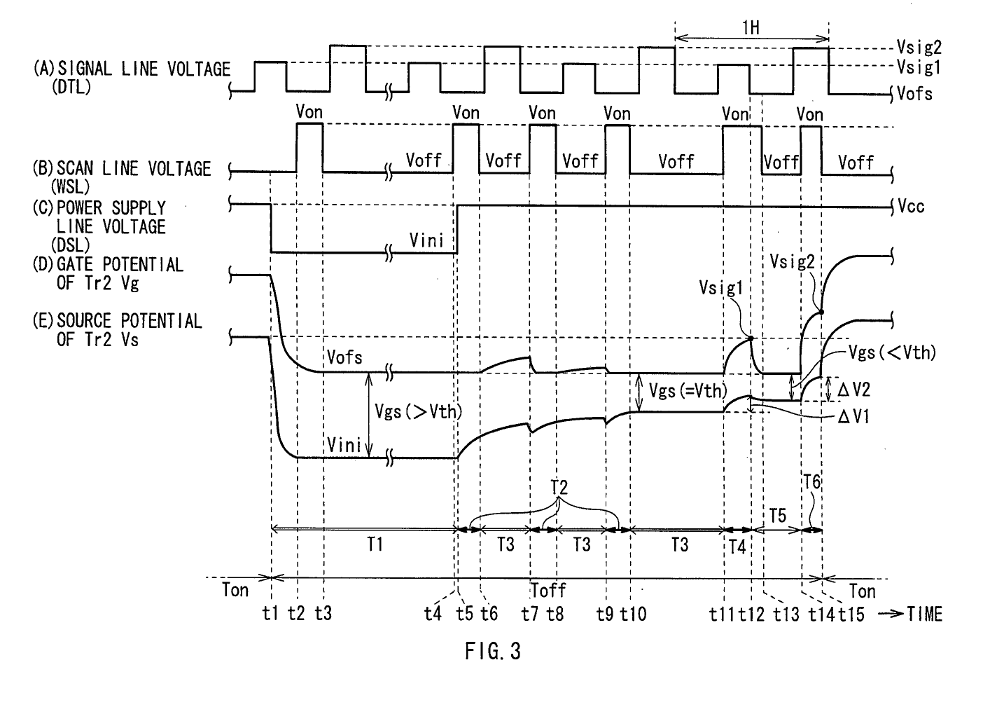

Referring to parts (A) to (E) in FIG. 3, the detailed display drive operation in the embodiment will be described. Parts (A) to (E) in FIG. 3 are examples of various timing waveforms. Parts (A) to (C) in FIG. 3 illustrate signal pulses applied to the signal line DTL, the scan line WSL, and the power supply line DSL, respectively. Parts (D) and (E) in FIG. 3 illustrate the waveforms of the gate potential Vg and the source potential Vs, respectively, in the drive transistor Tr2. In the embodiment, the three voltage values (Vsig1 (>Vofs), Vofs, and Vsig2) as signal line pulses, the two voltage values (Von and Voff) as scan line pulses, and the two voltage values (Vcc and Vini) as power supply line pulses are output while being switched.

A period from timing t1 to timing t15 which will be described later is a light-off period Toff in which the organic EL element 12 is in the light-off state. The drive circuit 20 performs the display driving in the two-step driving method in the light-off period Toff. Concretely, Vth correction preparing operation, Vth correcting operation, operation of applying the gray-scale interpolation voltage Vsig1, and operation of applying the video signal voltage Vsig2 described below are performed in this order, and the gray-scale interpolating operation is performed.

Vth Correction Preparation Period T1: t1 to t5

First, at the end (timing t1) of a light-on period Ton, the drive circuit 20 performs preparation for correcting the threshold voltage Vth in the drive transistor Tr2 in each pixel 11. Concretely, first, at timing t1, the power supply line drive circuit 25 decreases the power supply line voltage from the voltage Vcc to the voltage Vini (part (C) in FIG. 3). Thereafter, in the period in which the signal line voltage is the voltage Vofs and the power supply line voltage is the voltage Vini (timings t2 to t3), the scan line drive circuit 23 sets a state where the scan line voltage is increased from the voltage Voff to the voltage Von (part (B) in FIG. 3). The source potential Vs of the drive transistor Tr2 decreases to the voltage Vini (part (E) in FIG. 3), and the organic EL element 12 turns off. On the other hand, the gate potential Vg of the drive transistor Tr2 also decreases by capacitive coupling via the retention capacitor Cs as the source potential Vs decreases (part (D) in FIG. 3). Since the scan line voltage becomes the voltage Von and the write transistor Tr1 is turned on, the gate potential Vg becomes equal to the signal line voltage (voltage Vofs).

As a result, the gate-source voltage Vgs in the drive transistor Tr2 becomes larger than the threshold voltage Vth of the drive transistor Tr2 (Vgs>Vth), and preparation of the Vth correction completes (timing t3). Thereafter, at timing t4 when the signal line voltage becomes the voltage Vofs and the power supply line voltage becomes the voltage Vini, the scan line drive circuit 23 increases the scan line voltage from the voltage Voff to the voltage Von (part (B) in FIG. 3).

After completion of the Vth correction preparation, the drive circuit 20 corrects the threshold voltage Vth until the drive transistor Tr2 enters a cutoff state (Vgs=Vth) (Vth correcting operation). It is sufficient to perform the Vth correcting operation once or a plurality of times as necessary. The case of performing the Vth correcting operation three times with intervals therebetween (Vth correction intervals) will be described here.

First Vth Correction Period T2: t5 to t6

At timing t5 when the signal line voltage is equal to the voltage Vofs and the scan line voltage is equal to the voltage Von, the power supply line drive circuit 25 increases the power supply line voltage from the voltage Vini to the voltage Vcc (part (C) in FIG. 3). The current Id flows between the drain and source of the drive transistor Tr2 and the source potential Vs rises (part (E) in FIG. 3). Subsequently, at timing t6 when the signal line voltage is held at the voltage Vofs and the power supply line voltage is held at the voltage Vcc, the scan line drive circuit 23 decreases the scan line voltage from the voltage Von to the voltage Voff (part (B) in FIG. 3). By the operation, the write transistor Tr1 is turned off, the gate of the drive transistor Tr2 becomes floating, and the Vth correction temporarily stops (the period shifts to the first Vth correction pause period T3).

First Vth Correction Pause Period T3: t6 to t7

In the period from the timing t6 to the timing t7, the Vth correction stops temporarily. At timing t6 after the first Vth correction, the source potential Vs is lower than the voltage value (Vofs (=Vg)−Vth) (Vs<(Vg−Vth)). In other words, the gate-source voltage Vgs is still larger than the threshold voltage Vth (Vgs>Vth). Consequently, the current Id flows between the drain and the source, and the source potential Vs continues rising (part (E) in FIG. 3). On the other hand, the gate potential Vg also rises due to the capacitive coupling via the retention capacitor Cs as the source potential Vs rises (part (D) in FIG. 3).

Second Vth Correction Period T2: t7 to t8

Subsequently, at timing t7 when the signal line voltage is equal to the voltage Vofs and the power supply line voltage is equal to the voltage Vcc, the scan line drive circuit 23 increases the scan line voltage from the voltage Voff to the voltage Von (part (B) in FIG. 3). Accordingly, the write transistor Tr1 enters the on-state, so that the gate potential Vg becomes equal to the signal line voltage (voltage Vofs) (part (D) in FIG. 3). Also at the timing t7, Vgs is larger than Vth (Vgs>Vth), the current Id flows between the drain and the source, and the source potential Vs continues rising (part (E) in FIG. 3). Subsequently, at timing t8 when the signal line voltage is held at the voltage Vofs and the power supply line voltage is held at the voltage Vcc, the scan line drive circuit 23 decreases the scan line voltage from the voltage Von to the voltage Voff (part (B) in FIG. 3). By the operation, the write transistor Tr1 enters the off-state, so that the Vth correction stops temporarily (the period shifts to the Vth correction pause period T3 (second time)).

Second Vth Correction Pause Period T3: t8 to t9

In the period from the timing t8 to the timing t9, the Vth correction stops temporarily. Since Vgs is larger than Vth (Vgs>Vth) like in the first Vth correction pause period T3, the current Id flows between the drain and the source, the source potential Vs rises, and the gate potential Vg rises accordingly (parts (D) and (E) in FIG. 3).

Third Vth Correction Period T2 and Vth Correction Pause Period T3: t9 to t11

Subsequently, at timing t9 when the signal line voltage is equal to the voltage Vofs and the power supply line voltage is equal to the voltage Vcc, the scan line drive circuit 23 increases the scan line voltage from the voltage Voff to the voltage Von (part (B) in FIG. 3). Accordingly, the write transistor Tr1 enters the on-state, so that the gate potential Vg becomes equal to the voltage Vofs like in the second Vth correction period T2 (part (D) in FIG. 3). Since Vgs is larger than Vth (Vgs>Vth) also at the timing t9, the current Id flows between the drain and the source, and the source potential Vs rises. In the third Vth correction period T2, finally the drive transistor Tr2 enters the cutoff state (Vgs=Vth) (part (E) in FIG. 3). In other words, the Vth correction completes. The retention capacitor Cs is charged so that the voltage across the both ends becomes the threshold voltage Vth and, as a result, the gate-source voltage Vgs becomes equal to the threshold voltage Vth. Thereafter, at timing t10 when the signal line voltage is held at the voltage Vofs and the power supply line voltage is held at the voltage Vcc, the scan line drive circuit 23 decreases the scan line voltage from the voltage Von to the voltage Voff (part (B) in FIG. 3). By the operation, the write transistor Tr1 enters the off-state, so that the gate of the drive transistor Tr2 becomes floating. As a result, the gate-source voltage Vgs is held at the threshold voltage Vth regardless of the magnitude of the subsequent signal line voltage (the third Vth correction pause period T3: from timing t10 to timing t11).

By performing the Vth correction as described above, even in the case where the threshold voltage Vth varies among the pixels 11, the light emission luminance level of the organic EL element 12 is prevented from varying.

Gray-Scale Interpolation Writing Period T4: t11 to t12

Next, as will be described below, the drive circuit 20 applies the gray-scale interpolation voltage Vsig1 (gray-scale interpolation writing). The details of gray-scale interpolating operation using the gray-scale interpolation voltage Vsig1 will be described later. In the gray-scale interpolation writing period T4, at the same time with the gray-scale interpolation writing, the mobility μ in the drive transistor Tr2 is corrected (mobility correction). Concretely, first, at timing t11 when the signal line voltage is equal to the gray-scale interpolation voltage Vsig1 and the power supply line voltage is equal to the voltage Vcc, the scan line drive circuit 23 increases the scan line voltage from the voltage Voff to the voltage Von (part (B) in FIG. 3). By the operation, the write transistor Tr1 enters the on-state, so that the gate potential Vg of the drive transistor Tr2 increases from the voltage Vofs to the signal line voltage (Vsig1) (part (D) in FIG. 3). At this stage, the anode voltage of the organic EL element 12 is smaller than the voltage value (Vel+Vca) obtained by adding the threshold voltage Vel and the cathode voltage Vca in the organic EL element 12, so that the organic EL element 12 is in the cutoff state. In other words, in the gray-scale interpolation writing period T4, no current flows between the anode and the cathode of the organic EL element 12 (the organic EL element 12 does not emit light). Therefore, the current Id supplied from the drive transistor Tr2 flows in a device capacitor (not illustrated) existing in parallel between the anode and the cathode of the organic EL element 12, and the device capacitor is charged. As a result, the source potential Vs of the drive transistor Tr2 rises only by the potential difference ΔV1 (part (E) in FIG. 3), and the gate-source voltage Vgs becomes (Vsig1+Vth−ΔV1).

The rise amount (the potential difference ΔV1) of the source potential Vs increases as the mobility μ in the drive transistor Tr2 becomes higher. In other words, the gate-source voltage Vgs in the drive transistor Tr2 having relatively low mobility μ is larger than that in the drive transistor Tr2 having relatively high mobility μ. Therefore, even in the case where the mobility μ varies among the plurality of pixels 11, variation in the current Id (light emission luminance level) is suppressed.

Bootstrap Suppressing Period T5: t12 to t14

The period from the end of application of the gray-scale interpolation voltage Vsig1 to start of the video signal writing period T6 (timing t12 to timing t14) is a bootstrap suppressing period T5. In the embodiment, as the details will be described later, after the signal line voltage is switched from the gray-scale interpolation voltage Vsig1 to Vofs, concretely, at timing t13 when the signal line voltage is equal to the voltage Vofs and the power supply line voltage is equal to the voltage Vcc, the scan line drive circuit 23 decreases the scan line voltage from the voltage Von to the voltage Voff (part (B) in FIG. 3). By the operation, the write transistor Tr1 enters the off-state, so that the gate of the drive transistor Tr2 becomes floating, and the writing to the gate (specifically, application of the gray-scale interpolation voltage Vsig1 and the voltage Vofs) is completed. As described above, in the embodiment, the switching from the voltage Von to the voltage Voff at the time of writing the gray-scale interpolation is performed within the voltage Vofs application period. In the bootstrap suppressing period T5, by the operation of switching the scan line voltage at the time of gray-scale interpolation writing (switching from the voltage Von to the voltage Voff), the bootstrap operation (rise in the source potential Vs) is suppressed (or prevented).

Video Signal Writing Period T6: t14 to t15

Next, the drive circuit 20 applies the video signal voltage Vsig2 (video signal writing). Simultaneously, the drive circuit 20 corrects the mobility μ in the drive transistor Tr2 (mobility correction). Concretely, first, at timing t14 when the signal line voltage is equal to the video signal voltage Vsig2 and the power supply line voltage is equal to the voltage Vcc, the scan line drive circuit 23 increases the scan line voltage from the voltage Voff to the voltage Von (part (B) in FIG. 3). By the operation, the write transistor Tr1 enters the on-state, so that the gate potential Vg of the drive transistor Tr2 rises to the signal line voltage (Vsig2) (part (D) in FIG. 3). Also at this stage, the organic EL element 12 is still in the cutoff state like in the gray-scale interpolation writing period T4, so that the organic EL element 12 does not emit light. Therefore, the current Id supplied from the drive transistor Tr2 flows in a device capacitor (not illustrated) in the organic EL element 12, and the device capacitor is charged. As a result, the source potential Vs of the drive transistor Tr2 rises only by the potential difference ΔV2 (part (E) in FIG. 3), and the gate-source voltage Vgs becomes (Vsig2+Vth−(ΔV1+ΔV2).

Like the potential difference ΔV1, the rise amount of the source potential Vs (the potential difference ΔV2) becomes larger as the mobility μ of the drive transistor Tr2 becomes higher. In other words, in the embodiment, by the rise in the source potential in the gray-scale interpolation writing period T4 and the rise in the source potential in the video signal writing period T6, variations in the current Id caused by variations in the mobility μ are eliminated.

Light Emission Period Ton

Thereafter, at timing t15 when the signal line voltage is held at the video signal voltage Vsig2 and the power supply line voltage is held at the voltage Vcc, the scan line drive circuit 23 decreases the scan line voltage from the voltage Von to the voltage Voff (part (B) in FIG. 3). By the operation, the write transistor Tr1 enters the off-state, so that the gate of the drive transistor Tr2 becomes floating. In a state where the gate-source voltage Vgs of the drive transistor Tr2 is held constant, the current Id flows between the drain and the source of the drive transistor Tr2. As a result, the source potential Vs of the drive transistor Tr2 rises and, interlockingly, the gate potential Vg also rises by the capacitive coupling via the retention capacitor Cs (parts (D) and (E) in FIG. 3). Accordingly, the anode voltage of the organic EL element 12 becomes larger than the voltage value (Vel+Vca) obtained by adding the threshold voltage Vel and the cathode voltage Vca in the organic EL element 12. Therefore, the current Id flows between the anode and the cathode of the organic EL element 12, and the organic EL element 12 emits light with desired luminance.

Repetition

Thereafter, the drive circuit 20 completes the light emission period Ton. Concretely, as described above, at timing t1, the power supply line drive circuit 25 decreases the power supply line voltage from the voltage Vcc to the voltage Vini (part (C) in FIG. 3). By the operation, the source potential Vs of the drive transistor Tr2 becomes the voltage Vini (part (E) in FIG. 3), the anode voltage of the organic EL element 12 becomes smaller than the voltage value (Vel+Vca), and the current Id does not flow between the anode and the cathode. As a result, at the timing t1 or later, the organic EL element 12 is turned off (the operation shifts to the light-off period Toff). In such a manner, the display driving is performed so that the light-on period Ton and the light-off period Toff are repeated periodically by frame periods. Simultaneously, the drive circuit 20 scans, for example, the power supply lines DSL and the scan lines WSL with the selection pulse and the control pulse, respectively in the row direction every 11H periods. In such a manner, the display operation in the display device 1 is performed.

### 2. Gray-Scale Interpolating Operation

### 2-1 Basic Operation

Subsequently, the gray-scale interpolating operation (gray-scale interpolating operation of the two-step driving method) using the gray-scale interpolation voltage Vsig1 will be described. The signal line drive circuit 24 applies the gray-scale interpolation voltage Vsig1 prior to application of the video signal voltage Vsig2 to each of the signal lines DTL and, as will be described below, performs driving to vary the voltage value of the gray-scale interpolation voltage Vsig1 over a plurality of voltage values for each of the value (gray-scale level) of the video signal voltage Vsig2.

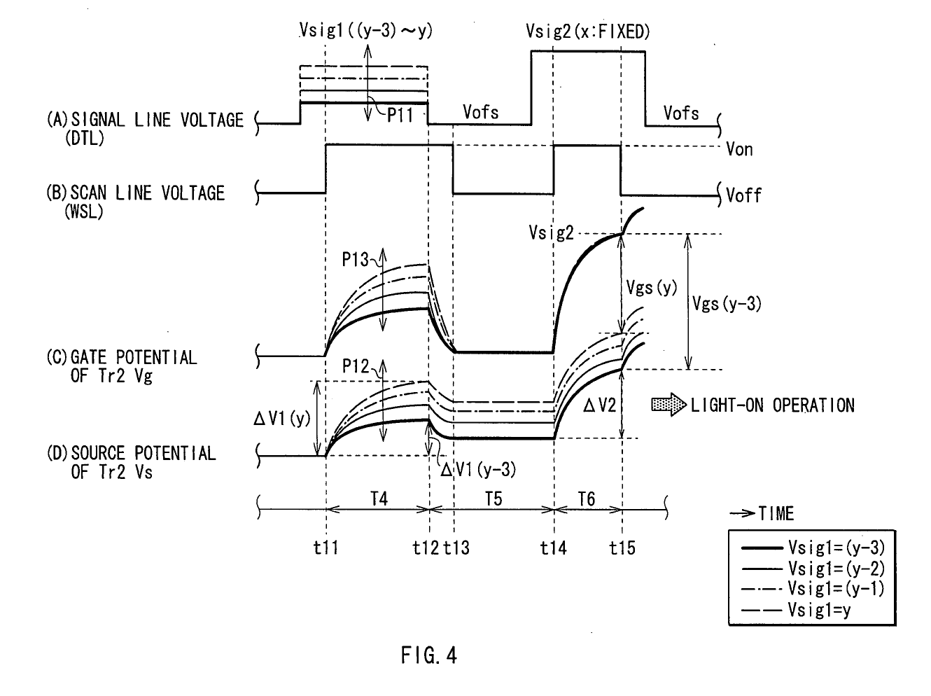

Concretely, in the gray-scale interpolation writing period T4, the signal line drive circuit 24 makes the gray-scale interpolation voltage Vsig1 vary over a plurality of voltage values (in this case, y, y−1, y−2, and y−3) for the video signal voltage Vsig2 which is set to the voltage value x (P11 in part (A) in FIG. 4). Although it has been described that the source potential Vs of the drive transistor Tr2 increases only by the potential difference ΔV1 by application of the gray-scale interpolation voltage Vsig1, the degree of increase changes according to the voltage value of the gray-scale interpolation voltage Vsig1 (P12 in part (D) in FIG. 4). Specifically, according to the voltage value of the gray-scale interpolation voltage Vsig1, the potential difference ΔV1 after the gray-scale interpolation writing changes. For example, the potential difference ΔV1(y) when the gray-scale interpolation voltage Vsig1 is set to y is larger than the potential difference ΔV1(y−3) when the gray-scale interpolation voltage Vsig1 is set to (y−3). The gate potential Vg also rises interlockingly with the rise in the source potential Vs (P13 in part (C) in FIG. 4).

On the other hand, in the video signal writing period T6, the rise amount (the potential difference ΔV2) of the source potential Vs of the drive transistor Tr2 is constant regardless of the voltage value of the gray-scale interpolation voltage Vsig1 (part (D) in FIG. 4). The reason is that the potential difference ΔV2 is determined by the voltage value (x) of the video signal voltage Vsig2. After completion of the period, the gate potential Vg is equal to the video signal voltage Vsig2 (=x) (part (C) in FIG. 4).

Therefore, by making the voltage value of the gray-scale interpolation voltage Vsig1 vary with respect to the video signal voltage Vsig2, the gate-source voltage Vgs after application of the video signal voltage Vsig2 (light emitting operation) is changed. For example, the gate-source voltage Vgs(y) when the gray-scale interpolation voltage Vsig1 is set to y becomes smaller than the gate-source voltage Vgs(y−3) when the gray-scale interpolation voltage Vsig1 is set to y−3.

In other words, in the embodiment, the gray-scale interpolation voltage Vsig1 is applied while being varied over a plurality of voltage values with respect to the video signal voltage Vsig2 in the two-step driving method. As the details will be described later, the gray-scale in the video signal voltages Vsig2 are interpolated by using the voltage values of the gray-scale interpolation voltage Vsig1. By the interpolation, the larger number of gray-scale levels than the number of output gray-scale levels (the number of gray-scale expressions in the video signal voltage Vsig2) which is originally provided by the signal line drive circuit 24 are expressed. For example, in the case where the number of gray-scale levels in the video signal voltage Vsig2 is m-bit gray-scale and the gray-scale interpolation voltage Vsig1 is changed by the amount of 2ⁿ, gray-scale of “n” bits (2ⁿ-gray-scale) are interpolated to the original m-bit gray-scale. Consequently, (m+n)-bit gray-scale is finally expressed. Concretely, in the case where the gray-scale in the video signal voltage Vsig2 is set to 8-bit gray-scale, by making the voltage value of the gray-scale interpolation voltage Vsig1 vary to four values of y, y−1, y−2, and y−3 with respect to a certain video signal voltage Vsig2(x), gray-scale of total two bits (four gray-scale levels) are interpolated, and total 10-bit gray-scale is expressed.

### 2-2 Bootstrap Suppressing (Preventing) Operation

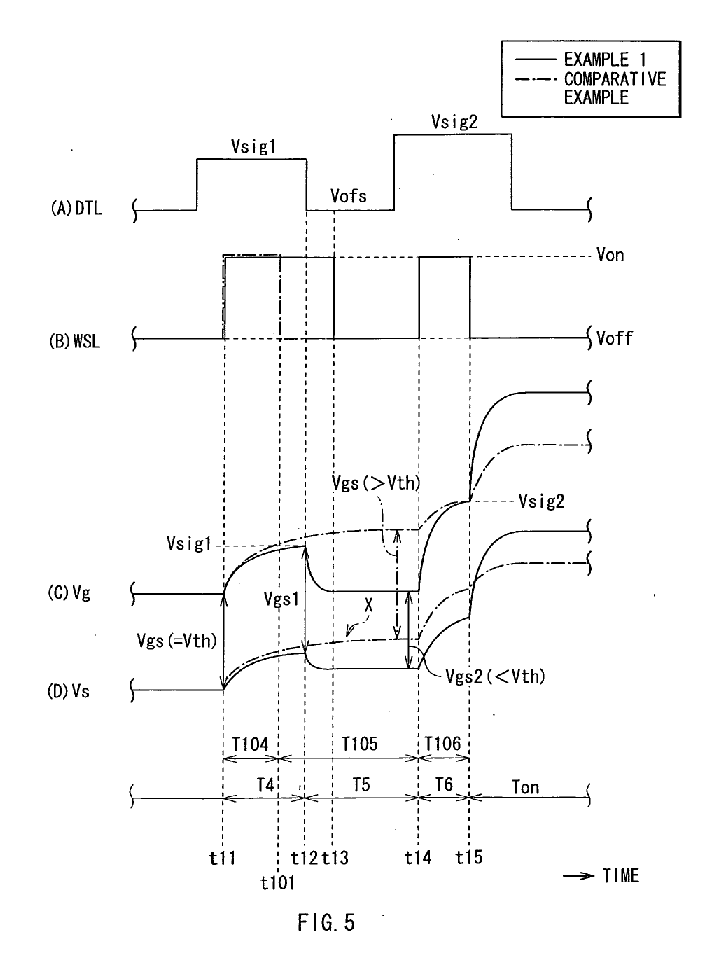

In the embodiment, as described above, in the period between the gray-scale writing period T4 and the video signal writing period T6, rise in the source potential Vs is suppressed, so that the bootstrap operation is suppressed (prevented). In the following, the action and effect of the bootstrap suppressing operation will be described with comparative example. Parts (A) to (D) in FIG. 5 illustrate timing waveforms of display driving operation in the case of the embodiment (example 1) and a comparative example. For simplicity, FIG. 5 illustrates around a portion from timing t11 to timing t15 on (A) signal line voltage, (B) scan line voltage, (C) gate potential Vg, and (D) source potential Vs.

In the comparative example, operations are performed in each of the Vth correction preparation period T1, the Vth correction period T2, and the Vth correction pause period T3 at timings similar to those of the embodiment. In the comparative example, the timing of switching the scan line voltage value (switching from the voltage Von to the voltage Voff) at the time of gray-scale interpolation writing is different from that of the embodiment. Specifically, in the comparative example, the scan line voltage is increased from the voltage Voff to the voltage Von at timing t11 when the signal line voltage is equal to the gray-scale interpolation voltage Vsig1, and the scan line voltage is then decreased from the voltage Von to the voltage Voff at timing t101 when the signal line voltage is held at the gray-scale interpolation voltage Vsig1 (part (B) in FIG. 5). In the comparative example, before the signal line voltage is switched from the gray-scale interpolation voltage Vsig1 to the voltage Vofs, the scan line voltage is switched from the voltage Von to the voltage Voff. The power supply line voltage is held at the voltage Vcc during the period from the timing t11 to the timing t101 (not illustrated in FIG. 5). In the comparative example, the period from the timing t11 to the timing t101 corresponds to the gray-scale interpolation writing period T104, and the gate potential Vg at the end (timing t101) of application of the gray-scale interpolation voltage Vsig1 becomes equal to the gray-scale interpolation voltage Vsig1.

In the comparative example as described above, the period from the end of application of the gray-scale interpolation voltage Vsig1 to the start of application of the video signal voltage Vsig2 (the period in which the signal line voltage is equal to the voltage Vofs) is the bootstrap period (T105). In other words, the source potential Vs rises (X in part (D) in FIG. 5). Since the rise (bootstrap operation) in the source potential Vs promotes mobility correction, the mobility correction amount increases. As the source potential Vs rises, the gate potential Vg rises, and the gate-source voltage Vgs becomes higher than the threshold voltage Vth.

On the other hand, in the embodiment (example 1), the scan line drive circuit 23 applies the voltage Von to a scan line at timing t11 when the signal line voltage is equal to the gray-scale interpolation voltage Vsig1, and the voltage Von is switched to the voltage Voff after the signal line voltage changes from the gray-scale interpolation voltage Vsig1 to the voltage Vofs (timing t13). In other words, within the period of applying the voltage Vofs after application of the gray-scale interpolation voltage Vsig1 to the signal line DTL, the scan line voltage is switched from the voltage Von to the voltage Voff.

In the embodiment, the gray-scale interpolation voltage Vsig1 and the voltage Vofs are applied in order to the gate of each of the pixels 11. As a result, as compared with the gate-source voltage Vgs1 immediately after the gray-scale interpolation writing period T4 (timing t12), in the bootstrap suppressing period T5, the gate-source voltage Vgs2 is suppressed only by the amount of ((Vsig1−Vofs)×write gain Gin). In other words, until the video signal voltage Vsig2 is applied, Vgs is smaller than Vth (Vgs<Vth), so that the bootstrap operation is not performed, and the source potential Vs does not rise. As a result, mobility correction is suppressed (the mobility correction amount decreases).

### 2-3. Gamma Curve Generating Operation

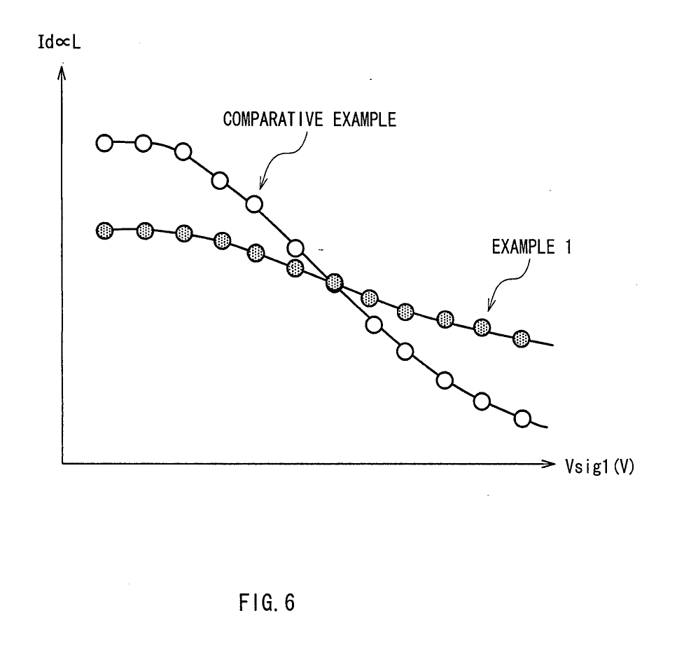

FIG. 6 illustrates an example of the relation between the gray-scale interpolation voltage Vsig1 in the video signal voltage Vsig2 and the current Id (proportional to the light emission luminance level L of the organic EL element 12) in the embodiment (example 1) and that in the comparison example. Each of the characteristic diagrams of the example 1 and the comparative example expresses the tendency that as the gray-scale interpolation voltage Vsig1 increases, the current Id decreases. The tilt is sharp in the comparative example. On the other hand, the tilt is gentle in the example. It is due to the fact that the mobility correction amount in the period after the gray-scale interpolation writing before the video signal voltage application in the example and that in the comparative example are different from each other. As described above, in the comparative example, after the gray-scale interpolation writing period T104, the bootstrap period T105 follows. The mobility correction amount increases due to the rise in the source potential Vs. On the other hand, in the example 1, after the gray-scale interpolation writing period T4, the bootstrap suppressing period T5 follows. The source potential Vs does not rise, and the mobility correction amount is small. As a result, a change in the current (current to drive the light emitting element) accompanying the rise in the gray-scale interpolation voltage becomes smaller. In other words, the tilt in the current change characteristic of the gray-scale interpolation voltage Vsig1 in the example 1 is gentler than that in the comparative example.

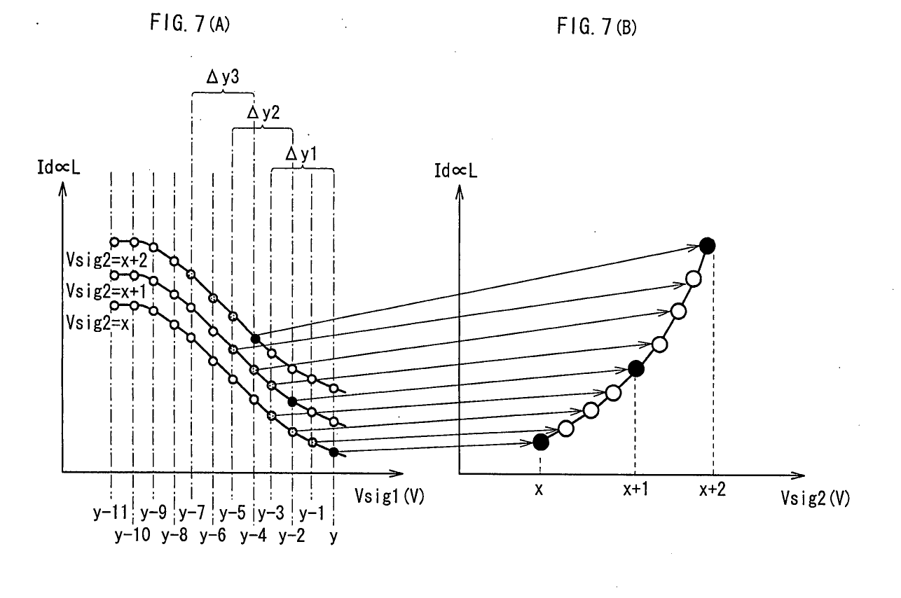

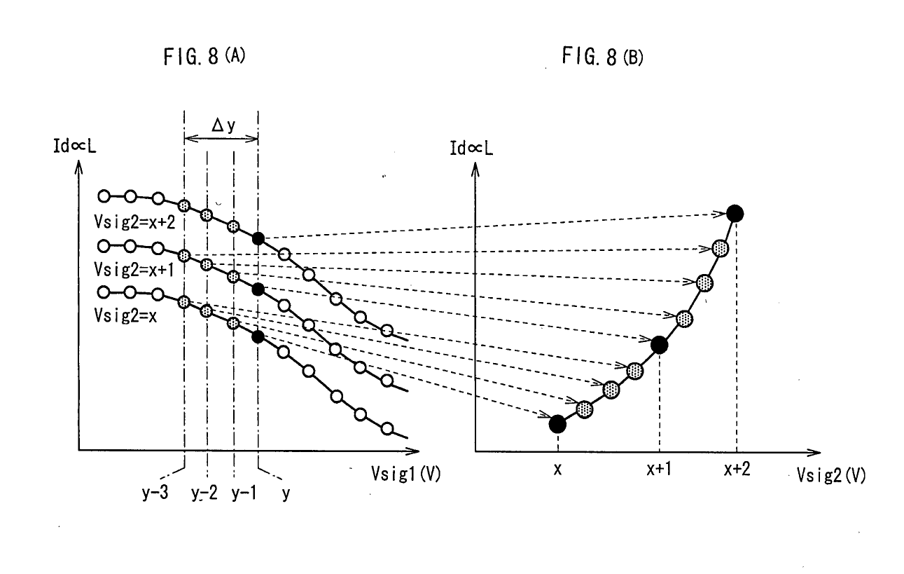

A change in the current Id for the gray-scale interpolation voltage Vsig1 varies among the voltage values of the video signal voltage Vsig2. In other words, even when the voltage value written as the gray-scale interpolation voltage Vsig1 is the same, if the voltage values of the video signal voltage Vsig2 are different, different currents Id are obtained. FIGS. 7A and 7B illustrate the relation between the gray-scale interpolation voltage Vsig1 and the video signal voltage Vsig2 and the current Id in the comparative example, and FIGS. 8A and 8B illustrate the relation in the example. Each of FIGS. 7A and 8A illustrates the current change characteristic of the gray-scale interpolation voltage Vsig1 in the case where the voltage values of the video signal voltage Vsig2 are x, x+1, and x+2. Each of FIGS. 7B and 8B shows the gamma curve indicative of the relation between the current Id and the video signal voltage Vsig2 (gamma curve after the gray-scale interpolation).

In the basic operation (parts (A) to (D) in FIG. 4), the case of performing the gray-scale interpolation while varying the gray-scale interpolation voltage Vsig1 over a plurality of voltage values (y, y−1, y−2, and y−3) with respect to the video signal voltage Vsig2 of the voltage value “x” has been described. Concretely, the gamma curve is generated as follows. Specifically, the gray-scale interpolation voltage Vsig1 is varied over a plurality of voltage values for each of the voltage values (x, x+1, x+2, . . . ) of the video signal voltage Vsig2, and the gray-scale interpolation at the video signal voltage Vsig2 is performed by using the voltage values (FIGS. 7A and 7B and FIGS. 8A and 8B). FIGS. 7A and 7B and FIGS. 8A and 8B illustrate the case where, for example, the video signal voltage Vsig2 of 8-bit gray-scale is interpolated by two bits (four gray-scale levels), thereby obtaining the gamma curve of 10-bit gray-scale.

In the comparative example, as illustrated in FIG. 7A, the tilt in the current change characteristic of the gray-scale interpolation voltage Vsig1 is sharp, so that the range of a plurality of voltage values varied in the gray-scale interpolation voltage Vsig1 varies for each of the voltage values of the video signal voltage Vsig2. For example, in the case of setting the video signal voltage Vsig2 to a voltage value “x”, the gray-scale interpolation voltage Vsig1 has to be changed in the range of Δy1 (y−5 to y−2). In the case of setting the video signal voltage Vsig2 to voltage value x+1, the gray-scale interpolation voltage Vsig1 has to be changed in the range of Δy2 (y−4 to y−1). In the case of setting the video signal voltage Vsig2 to the voltage value x+2, the gray-scale interpolation voltage Vsig1 has to be changed in the range of Δy3 (y−3 to y). When such a variation occurs, the range of the voltage values which may be output as the gray-scale interpolation voltage Vsig1 has to be set to be wide in advance. A memory of such an amount has to be provided in a data driver (the signal line drive circuit 24 and the like).

On the other hand, in the embodiment (example 1), as illustrated in FIG. 8A, the tilt of the current change characteristic of the gray-scale interpolation voltage Vsig1 is gentle, so that the range of the voltage values of the gray-scale interpolation voltage Vsig1 does not easily vary at each voltage value of the video signal voltage Vsig2. In other words, the voltage values of the gray-scale interpolation voltage Vsig1 may be set in almost the same range with respect to all of the tones of the video signal voltage Vsig2. For example, even in the case where the video signal voltage Vsig2 is set to any of the voltage values x, x+1, and x+2, it is sufficient to make the gray-scale interpolation voltage Vsig1 vary in the range of Δy(y−3 to y).

Therefore, the range of the voltage values which are output as the gray-scale interpolation voltage Vsig1 are set to the minimum range, so that an excessive memory does not have to be provided in the data driver (the signal line drive circuit 24 or the like). For example, in the case of performing gray-scale interpolation of two bits, the gray-scale interpolation voltage Vsig1 may be set so as to be varied to four values (voltage values y to y−3). In the case where the number of output gray-scale levels which are originally provided by the signal line drive circuit 24 is 8-bit gray-scale (256 gray-scale levels), gray-scale expression of total ten bits (1,024 gray-scale levels) may be realized.

In the embodiment as described above, the voltage Von is applied to the scan line WSL within the period of applying the gray-scale interpolation voltage Vsig1 to the signal line DTL, and switching from the voltage Von to the voltage Voff is performed within the period in which the voltage Vofs is applied to the signal line DTL. When the scan line voltage is switched within the period of applying the gray-scale interpolation voltage Vsig1 (before application of the voltage Vofs), in the period after writing of the gray-scale interpolation to writing of the video signal (the period of application of the voltage Vofs), the bootstrap operation is promoted, and the mobility correction amount increases. On the other hand, by performing the switching to the voltage Voff in the period of application of the voltage Vofs like in the embodiment, the bootstrap operation after the switching of the scan line voltage is suppressed (prevented). As a result, the mobility correction amount is reduced, and the tilt of the current change characteristic with respect to the gray-scale interpolation voltage Vsig1 is made gentle. Consequently, it becomes unnecessary to provide an excessive memory in a peripheral circuit such as a data driver. Therefore, while realizing reduction in cost, higher picture quality is realized.

### Second Embodiment

### 1. Display Drive Operation

Also in a second embodiment, in a manner similar to the first embodiment, as illustrated in FIGS. 1 and 2, in the display device 1, the drive circuit 20 performs display driving on the pixels 11 in the display panel 10 on the basis of the video signal 20A and the synchronization signal 20B. The drive current is injected into the organic EL element 12 in each of the pixels 11, holes and electrons are recombined, and light emission occurs. The generated light is taken to the outside and an image is displayed. In the following, the display drive operation in the embodiment will be described in detail.

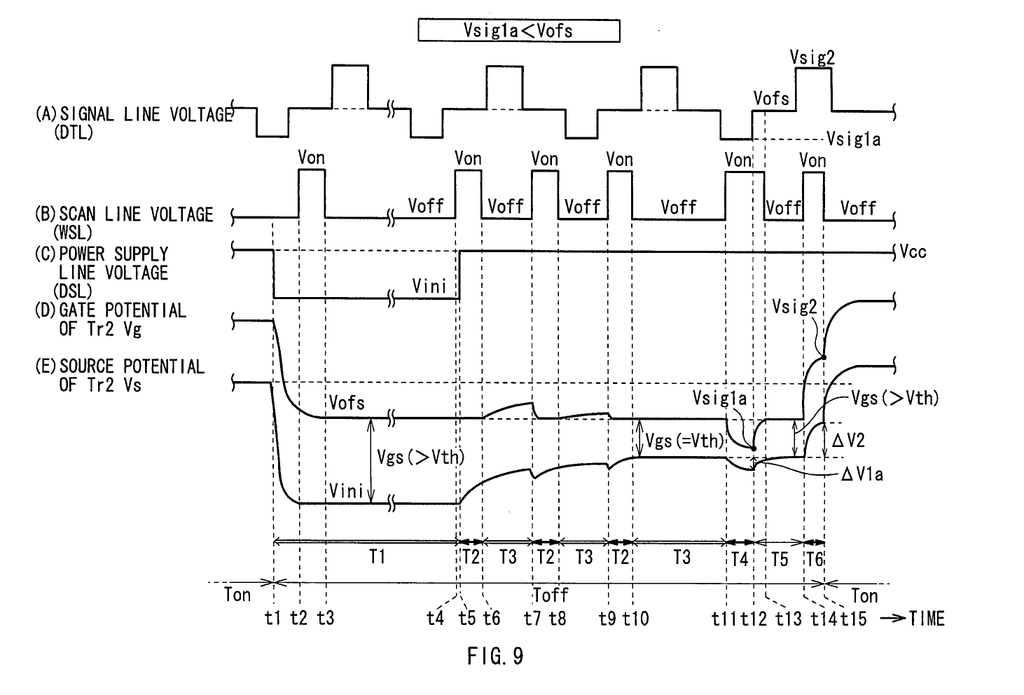

Parts (A) to (E) in FIG. 9 are various timing waveforms of the embodiment. Parts (A), (B), and (C) in FIG. 9 illustrate signal pulses applied to the signal line DTL, the scan line WSL, and the power supply line DSL, respectively. Parts (D) and (E) in FIG. 9 illustrate the waveforms of the gate potential Vg and the source potential Vs, respectively, in the drive transistor Tr2. In the second embodiment, like the first embodiment, a period from timing t1 to timing t15 is a light-off period Toff of the organic EL element 12. The drive circuit 20 performs the display driving in the two-step driving method in the light-off period Toff. Concretely, Vth correction preparation, Vth correction, gray-scale interpolation writing, and video signal writing are performed in this order, and the gray-scale interpolating operation is performed. Among them, with respect to the Vth Correction preparation and the Vth correction, operations similar to the first embodiment are performed at similar timings (Vth correction preparation period T1 to Vth correction pause period T3). In the gray-scale interpolation writing period T4, the mobility correction is performed simultaneously with the gray-scale interpolation writing. Also in the video signal writing period T6, the mobility correction is performed simultaneously with the video signal writing.

Further, a period between the gray-scale interpolation writing period T4 and the video signal writing period T6 is the bootstrap suppressing period T5. Specifically, like in the first embodiment, the scan line drive circuit 23 applies the voltage Von to the scan line WSL within the period of applying a gray-scale interpolation voltage Vsig1a, and the voltage Von is switched to the voltage Voff within the period of applying the voltage Vofs. In such a manner, in the period from the gray-scale interpolation writing to the video signal writing, the bootstrap operation is suppressed. Thereafter, in the video signal writing period T6, in a manner similar to the first embodiment of the invention, the video signal voltage Vsig2 is applied to the signal line DTL (timing t14 to timing t15), and then the period moves to the light-on period Ton.

In the embodiment, the signal line drive circuit 24 outputs the gray-scale interpolation voltage Vsig1a in three voltages (the gray-scale interpolation voltage Vsig1a, the voltage Vofs, and the video signal voltage Vsig2) applied to the signal line DTL as a voltage value lower than the voltage Vofs as a basic voltage. In the embodiment, the three voltage values (Vsig1a (<Vofs), Vofs, and Vsig2) as signal line pulses (signal line voltages), the two voltage values (Von and Voff) as selection pulses (scan line voltages), and the two voltage values (Vcc and Vini) as control pulses (power supply line voltages) are output while being switched. In the following, an operation of applying the gray-scale interpolation voltage Vsig1a and the gray-scale interpolation operation using the gray-scale interpolation voltage Vsig1a will be described.

Gray-Scale Interpolation Writing Operation

The scan line drive circuit 23 increases the scan line voltage from the voltage Voff to the voltage Von at timing t11 when the signal line voltage is equal to the gray-scale interpolation voltage Vsig1a and the power supply line voltage is equal to the voltage Vcc (part (B) in FIG. 9). By the operation, the write transistor Tr1 enters the on-state, so that the gate potential Vg rises to the signal line voltage at this time (Vsig1a) (part (D) in FIG. 9). At this stage, the organic EL element 12 is still in the cutoff state like in the first embodiment, so that no current flows in the organic EL element 12. Therefore, the current Id supplied from the drive transistor Tr2 flows in a device capacitor (not illustrated) in the organic EL element 12, and the device capacitor is charged. As a result, the source potential Vs of the drive transistor Tr2 drops only by the potential difference ΔV1a (part (E) in FIG. 9), and the gate-source voltage Vgs becomes (Vsig1+Vth−ΔV1a).

The drop amount of the source potential Vs (the potential difference ΔV1a) becomes larger as the mobility μ of the drive transistor Tr2 becomes higher. In other words, the gate-source voltage Vgs in the drive transistor Tr2 having relatively lower mobility μ is larger than that in the drive transistor Tr2 having relatively higher mobility μ. Therefore, even in the case where the mobility μ varies among the plurality of pixels 11, variations in the current Id (light emission luminance level) caused by the variations in the mobility μ are suppressed.

After application of the gray-scale interpolation voltage Vsig1a, the period moves to the bootstrap suppressing period T5, and the bootstrap operation is suppressed (or prevented). Concretely, the scan line drive circuit 23 decreases the scan line voltage from the voltage Von to the voltage Voff at timing t13 when the signal line voltage is equal to the voltage Vofs and the power supply line voltage is equal to the voltage Vcc ((B) in FIG. 9). By the operation, the write transistor Tr1 is turned off and the writing to the gate of the drive transistor Tr2 is completed.

### 2. Gray-Scale Interpolating Operation

### 2-1. Basic Operation

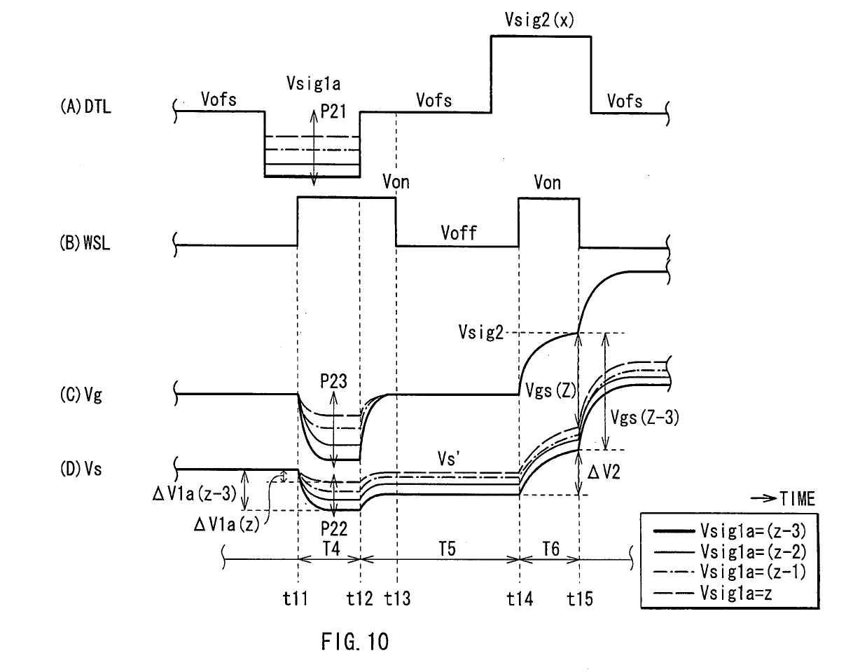

Subsequently, the gray-scale interpolating operation (gray-scale interpolating operation of the two-step driving method) using the gray-scale interpolation voltage Vsig1a will be described. The signal line drive circuit 24 performs driving on each of the signal lines DTL to vary the voltage value of the gray-scale interpolation voltage Vsig1 over a plurality of voltage values for each of the value (gray-scale level) of the video signal voltage Vsig2. Concretely, in the gray-scale interpolation writing period T4, the signal line drive circuit 24 makes the gray-scale interpolation voltage Vsig1a vary over a plurality of voltage values (in this case, z, z−1, z−2, and z−3) for the video signal voltage Vsig2 which is set to the voltage value x (P21 in part (A) in FIG. 10). Although the source potential Vs of the drive transistor Tr2 decreases only by the potential difference ΔV1a by application of the gray-scale interpolation voltage Vsig1a, the degree of decrease changes according to the voltage value of the gray-scale interpolation voltage Vsig1a (P22 in part (D) in FIG. 10). Specifically, according to the voltage value of the gray-scale interpolation voltage Vsig1a, the potential difference ΔV1a after application of the gray-scale interpolation voltage changes. For example, the potential difference ΔV1a(z) when the gray-scale interpolation voltage Vsig1a is set to z is smaller than the potential difference ΔV1a(z−3) when the gray-scale interpolation voltage Vsig1a is set to (z−3). The gate potential Vg also decreases interlockingly with the decrease in the source potential Vs (P23 in part (C) in FIG. 10).

On the other hand, in the video signal writing period T6, like in the first embodiment, the drop amount (the potential difference ΔV2) of the source potential Vs of the drive transistor Tr2 is constant regardless of the voltage value of the gray-scale interpolation voltage Vsig1a (part (D) in FIG. 10). After completion of the period, the gate potential Vg is equal to the video signal voltage Vsig2 (=x) (part (C) in FIG. 10).

Therefore, by making the voltage value of the gray-scale interpolation voltage Vsig1a vary with respect to the video signal voltage Vsig2, the gate-source voltage Vgs after application of the video signal voltage Vsig2 (in the light emitting operation) is changed. For example, the gate-source voltage Vgs(z) when the gray-scale interpolation voltage Vsig1a is set to z becomes smaller than the gate-source voltage Vgs(z−3) when the gray-scale interpolation voltage Vsig1a is set to z−3.

In other words, also in the embodiment using the gray-scale interpolation voltage Vsig1a (<Vofs), like in the above-described first embodiment, the gray-scale interpolation voltage Vsig1a is applied while being varied over a plurality of voltage values with respect to the video signal voltage Vsig2 in the two-step driving method. The gray-scale interpolation in the video signal voltage Vsig2 is performed by using the voltage values. By the interpolation, the larger number of gray-scale levels than the number of output gray-scale levels (the number of gray-scale expressions in the video signal voltage Vsig2) which is originally set in the signal line drive circuit 24 are expressed.

### 2-2 Bootstrap Suppressing (Preventing) Operation

Also in the second embodiment, like in the above-described first embodiment, the scan line drive circuit 23 switches the scan line voltage from the voltage Von to the voltage Voff within the period in which the voltage Vofs is applied at the time of the gray-scale interpolation writing. By the operation, in the second embodiment, the gray-scale interpolation voltage Vsig1a and the voltage Vofs are applied to the gate of each of the pixels 11.

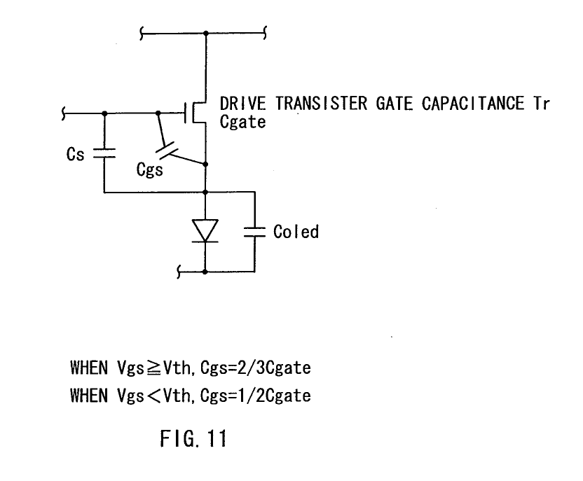

Referring now to FIG. 11, fluctuations in the source potential Vs in the gray-scale interpolation writing period T4 and the bootstrap suppressing period T5 will be examined. First, the write gain Gin after Vth correction (just before the gray-scale interpolation writing period T4) is expressed by the following equation (1) where Coled denotes organic EL element capacitance. Since the voltage Vgs becomes equal to or larger than the voltage Vth (Vgs≧Vth) after the Vth correction, the gate-source capacitance Cgs in the drive transistor Tr2 is expressed by the following equation (2) where Cgate denotes drive transistor gate capacitance. In the case where Vgs<Vth, the gate-source capacitance Cgs is expressed by the following equation (3).

Gin=1−[(Cs+Cgs)/(Cs+Cgs+Coled)] (1)

Cgs=(2/3)×Cgate (2)

Cgs=(1/2)×Cgate (3)

When the gate potential Vg fluctuates from the voltage Vofs to the gray-scale interpolation voltage Vsig1a in the gray-scale interpolation writing period T4 (timing t11 to timing t12), the source potential Vs rises only by the amount of (Vofs−Vsig1a)×Gin) (timing t12 to timing t13). In other words, the source potential Vs is expressed as the following equation (4).

Vs=(Vofs−Vth)+(Vsig1a−Vofs)×(1−Gin) (4)

When the signal line voltage fluctuates from the gray-scale interpolation voltage Vsig1a to the voltage Vofs in a state where the scan line voltage is held at the voltage Von (timing t13), the gate potential Vg becomes again the voltage Vofs. The source potential Vs is influenced by the fluctuation in the write gain, accompanying fluctuations in the operating point of the drive transistor Tr2. The write gain (Gin′) when the gate potential Vg fluctuates from the gray-scale interpolation voltage Vsig1a to the voltage Vofs will be examined.

First, the gate-source voltage Vgs of the drive transistor Tr2 becomes smaller than the threshold voltage Vth, Cgs=(1/2)×Cgate is obtained by the above equation (3). Consequently, the source potential Vs′ after application of the gray-scale interpolation voltage Vsig1a and the voltage Vofs is expressed by the following equation (5) where Gin′>Gin.

Vs′=(Vofs−Vth)+(Vofs−Vsig1a)×(Gin′−Gin) (5)

Therefore, the lower the gray-scale interpolation voltage Vsig1a is, the lower the source potential Vs′ is and the larger the gate-source voltage Vgs just before application of the video signal voltage Vsig2 is. As a result, in the bootstrap suppressing period T5, the bootstrap operation is not performed, and rise in the source potential Vs is suppressed. Thus, the mobility correction is suppressed (the mobility correction amount becomes smaller).

### 2-3. Gamma Curve Generating Operation

Also in the second embodiment, like in the first embodiment, the relation between the gray-scale interpolation voltage Vsig1a in the video signal voltage Vsig2 and the current Id (the current change characteristic of the gray-scale interpolation voltage Vsig1a) expresses the tendency that as the gray-scale interpolation voltage Vsig1 increases, the current Id decreases, and the tilt is gentle. It is due to the fact that, as described above, in the bootstrap suppressing period T5 after the gray-scale interpolation writing period T4, rise in the source potential Vs is suppressed, and the mobility correction amount decreases. As a result, a change in the current (current to drive the light emitting element) accompanying the rise in the gray-scale interpolation voltage Vsig1a becomes smaller. In other words, the tilt in the current change characteristic of the gray-scale interpolation voltage Vsig1a becomes gentler.

At the time of generating a gamma curve by using the gray-scale interpolation voltage Vsig1a having such a current change characteristic, in a manner similar to the first embodiment, it is sufficient to make the gray-scale interpolation voltage Vsig1a vary over a plurality of voltage values for each value of the video signal voltage Vsig2, and perform gray-scale interpolation in the video signal voltage Vsig2 by using the voltage values. Since the tilt of the current change characteristic of the gray-scale interpolation voltage Vsig1a is gentle, like in the first embodiment, the range of voltage values which are output as the gray-scale interpolation voltage Vsig1 is set to the minimum range.

In the embodiment, the voltage Von is applied to the scan line WSL within the period of applying the gray-scale interpolation voltage Vsig1a, the switching from the voltage Von to the voltage Voff is performed within the period of applying the voltage Vofs, and the gray-scale interpolation voltage Vsig1a is set to be lower than the voltage Vofs. In such a manner, the bootstrap operation after switching of the scan line voltage from the voltage Von to the voltage Voff is suppressed (prevented). As a result, the mobility correction amount is reduced, and the tilt of the current change characteristic with respect to the gray-scale interpolation voltage Vsig1a is made gentler. In the embodiment in which the gray-scale interpolation voltage Vsig1a is set to a voltage value lower than the voltage Vofs in addition to the bootstrap suppressing operation, the tilt of the current change characteristic is gentler than that of the current change characteristic of the gray-scale interpolation voltage Vsig1 in the first embodiment. Therefore, an effect equivalent to or higher than that of the first embodiment is obtained.

### Third Embodiment

### 1. Display Drive Operation

Also in a third embodiment, in a manner similar to the first embodiment, in the display device 1 as illustrated in FIGS. 1 and 2, the drive circuit 20 performs display driving on the pixels 11 in the display panel 10 on the basis of the video signal 20A and the synchronization signal 20B. The drive current is injected into the organic EL element 12 in each of the pixels 11, thereby causing light emission. The generated light is taken to the outside and an image is displayed. In the following, the display drive operation in the embodiment will be described in detail.

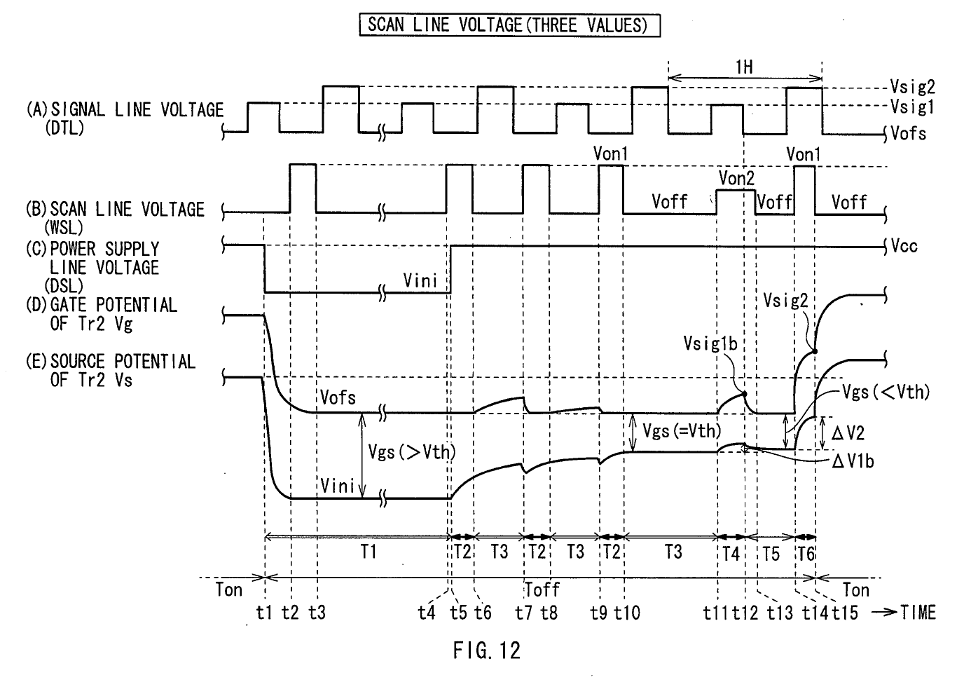

Parts (A) to (E) in FIG. 12 illustrate various timing waveforms of the embodiment. Parts (A), (B), and (C) in FIG. 12 illustrate signal line voltages applied to the signal line DTL, the scan line WSL, and the power supply line DSL, respectively. Parts (D) and (E) in FIG. 12 illustrate the waveforms of the gate potential Vg and the source potential Vs, respectively, in the drive transistor Tr2. Also in the third embodiment, like in the first embodiment, a period from timing t1 to timing t15 is a light-off period Toff of the organic EL element 12. The drive circuit 20 performs the display driving in the two-step driving method in the light-off period Toff. Concretely, Vth correction preparation, Vth correction, gray-scale interpolation writing, and video signal writing are performed in this order, and the gray-scale interpolating operation is performed. Among them, with respect to the Vth correction preparation and the Vth correction, operations similar to the first embodiment are performed at similar timings (Vth correction preparation period T1 to Vth correction pause period T3). In the gray-scale interpolation writing period T4, the mobility correction is performed simultaneously with the gray-scale interpolation writing. Also in the video signal writing period T6, the mobility correction is performed simultaneously with the video signal writing.

Further, a period between the gray-scale interpolation writing period T4 and the video signal writing period T6 is the bootstrap suppressing period T5. Specifically, like in the first embodiment, the scan line drive circuit 23 applies the voltage Von2 to the scan line WSL within the period of applying the gray-scale interpolation voltage Vsig1, and the voltage Von2 is switched to the voltage Voff within the period of applying the voltage Vofs. In such a manner, in the period from the gray-scale interpolation writing to the video signal writing, the bootstrap operation is suppressed. After the bootstrap suppressing period T5, the video signal voltage Vsig2 is applied and, after that, the period moves to the light-on period Ton.

In the embodiment, the scan line drive circuit 23 outputs the scan line voltage in three voltage values (Von1, Von2, and Voff where Von1>Von2). In the embodiment, the three voltage values (Vsig1 (>Vofs), Vofs, and Vsig2) as signal line pulses (signal line voltages), the three voltage values (Von1, Von2, and Voff) as selection pulses (scan line voltages), and the two voltage values (Vcc and Vini) as control pulses (power supply line voltages) are output while being switched. The voltages Von1 and Von2 are voltages for setting the write transistor Tr1 in the on-state and have values (constant value) equal to or higher than the on-voltage of the write transistor Tr1. The voltages Von1 and Von2 correspond to examples of a “first on-voltage” and a “second on-voltage”, respectively, in the present invention.

The voltage Von1 as higher one of the voltages Von1 and Von2 is applied to the scan lines WSL in the Vth interpolation preparation period T1, the Vth correction period T2, and the video signal writing period T6. The voltage Von2 as lower one is applied to the scan lines WSL in the gray-scale interpolation writing period T4. In the following, the gray-scale interpolation writing operation and the gray-scale interpolating operation in the embodiment will be described.

Gray-Scale Interpolation Writing Operation

In the embodiment, the scan line drive circuit 23 increases the scan line voltage from the voltage Voff to the voltage Von2 at timing t11 when the signal line voltage is equal to the gray-scale interpolation voltage Vsig1 and the power supply line voltage is equal to the voltage Vcc (part (B) in FIG. 12). By the operation, the write transistor Tr1 enters the on-state, so that the gate potential Vg rises from the voltage Vofs to the voltage (Vsig1b) corresponding to the signal line voltage at this time (part (D) in FIG. 12). At this stage, like in the first embodiment, the organic EL element 12 is in the cutoff state, so that no current flows in the organic EL element 12. Therefore, the current Id supplied from the drive transistor Tr2 flows in a device capacitor (not illustrated) in the organic EL element 12, and the device capacitor is charged. As a result, the source potential Vs of the drive transistor Tr2 drops only by the potential difference ΔV1b (part (E) in FIG. 12), and the gate-source voltage Vgs becomes (Vsig1+Vth−ΔV1b).

The rise amount of the source potential Vs (the potential difference ΔV1b) becomes larger as the mobility μ of the drive transistor Tr2 becomes higher like in the first embodiment. Therefore, even in the case where the mobility μ varies among the plurality of pixels 11, variations in the current Id (light emission luminance level) caused by the variations in the mobility μ are suppressed.

After application of the gray-scale interpolation voltage Vsig1, the period moves to the bootstrap suppressing period T5, and the bootstrap operation is suppressed (or prevented). Concretely, the scan line drive circuit 23 decreases the scan line voltage from the voltage Von to the voltage Voff at timing t13 when the signal line voltage is equal to the voltage Vofs and the power supply line voltage is equal to the voltage Vcc (part (B) in FIG. 12). By the operation, the write transistor Tr1 is turned off and the writing to the gate of the drive transistor Tr2 is completed.

### 2. Gray-Scale Interpolating Operation

### 2-1. Basic Operation

Next, the gray-scale interpolating operation (gray-scale interpolating operation of the two-step driving method) in the embodiment will be described. In a manner similar to the first embodiment, the signal line drive circuit 24 performs driving on each of the signal lines DTL to vary the voltage value of the gray-scale interpolation voltage Vsig1 over a plurality of voltage values for each of the value (gray-scale level) of the video signal voltage Vsig2. In the gray-scale interpolation writing period T4, the source potential Vs rises, and the rise amount (the potential difference ΔV1b) varies according to the voltage value of the gray-scale interpolation voltage Vsig1. The gate potential Vg also increases interlockingly with the rise in the source potential Vs. On the other hand, in the video signal writing period T6, the rise amount of the source potential Vs of the drive transistor Tr2 is the potential difference ΔV2 (constant). Therefore, in a manner similar to the first embodiment, by making the voltage value of the gray-scale interpolation voltage Vsig1 vary with respect to the video signal voltage Vsig2, the gate-source voltage Vgs after application of the video signal is changed. By performing the gray-scale interpolation in the video signal voltage Vsig2 using the voltage values, the larger number of gray-scale levels than the number of output gray-scale levels which is originally set in the signal line drive circuit 24 are expressed.

### 2-2 Bootstrap Suppressing (Preventing) Operation

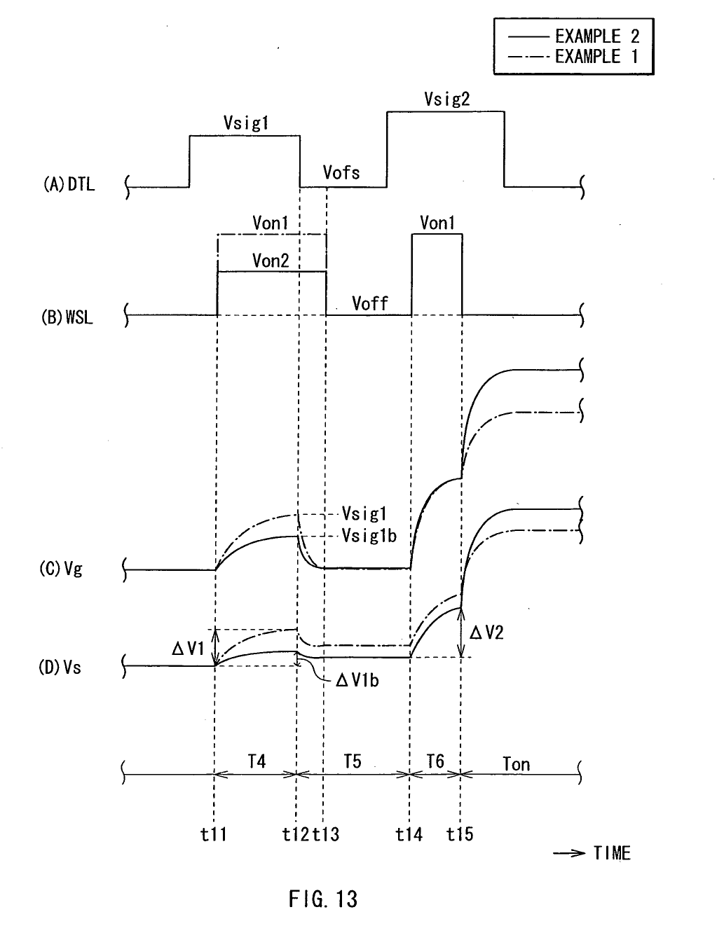

Also in the third embodiment, like in the above-described first embodiment, the scan line drive circuit 23 switches the scan line voltage from the voltage Von2 to the voltage Voff within the period in which the voltage Vofs is applied at the time of the gray-scale interpolation writing. By the operation, the rise in the source potential Vs is suppressed in the bootstrap suppressing period T5 after application of the gray-scale interpolation voltage Vsig1. FIG. 13 illustrates timing waveforms of the display drive operations in the cases of the first and third embodiments (Examples 1 and 2). FIG. 13 illustrates, for simplicity, around a portion from timing t11 to timing t15 in the waveforms on part (A) signal line voltage, part (B) scan line voltage, part (C) gate potential Vg, and part (D) source potential Vs. At the time of gray-scale interpolation voltage writing, the rise amount of the source potential Vs in Example 2 in which the voltage Von2 lower than the voltage Von1 is applied is smaller than that in Example 1 in which the same voltage Von1 as that in the case of applying the video signal voltage is applied to the scan lines WSL (ΔV1b<ΔV1). In the bootstrap suppressing period T5, the bootstrap operation is not performed, so that the rise in the source potential Vs is suppressed. As a result, the mobility correction is suppressed (the mobility correction amount becomes smaller) as compared with the foregoing embodiment. In the third embodiment, the tilt of the current change characteristic of the gray-scale interpolation voltage Vsig1 is gentler than that in the foregoing embodiment.

### 2-3. Gamma Curve Generating Operation

Also in the third embodiment, like in the first embodiment, the current change characteristic of the gray-scale interpolation voltage Vsig1 in the video signal voltage Vsig2 expresses the tendency that as the gray-scale interpolation voltage Vsig1 increases, the current Id decreases, and the tilt is gentle. It is due to the fact that, as described above, in the bootstrap suppressing period T5 after the gray-scale interpolation writing period T4, rise in the source potential Vs is suppressed, and the mobility correction amount decreases. As a result, a change in the current (current to drive the light emitting element) accompanying the rise in the gray-scale interpolation voltage Vsig1 becomes smaller. In other words, the tilt in the current change characteristic of the gray-scale interpolation voltage Vsig1 becomes gentler.

At the time of generating a gamma curve by using the gray-scale interpolation voltage Vsig1 having such a current change characteristic, in a manner similar to the first embodiment, it is sufficient to make the gray-scale interpolation voltage Vsig1 vary over a plurality of voltage values for each value of the video signal voltage Vsig2, and perform gray-scale interpolation in the video signal voltage Vsig2 by using the voltage values. Since the tilt of the current change characteristic of the gray-scale interpolation voltage Vsig1 is gentle, like in the first embodiment, the range of voltage values which are output as the gray-scale interpolation voltage Vsig1 is set to the minimum range.

In the embodiment, the scan line voltage is varied to three voltage values (Von1, Von2, and Voff). At the time of writing the video signal, the voltage Von is applied to the scan line WSL. At the time of performing the gray-scale interpolation, the voltage Von2 lower than the voltage Von1 is applied to the scan line WSL. In such a manner, the bootstrap operation after performing the gray-scale interpolation is suppressed (prevented). As a result, the mobility correction amount is reduced, and the tilt of the current change characteristic with respect to the gray-scale interpolation voltage Vsig1 is made gentler. Further, in the embodiment, an effect of the bootstrap suppression (the effect of the first embodiment) produced by switching the scan line voltage from the voltage Von to the voltage Voff at the time of performing the gray-scale interpolation within the period of applying the voltage Vofs is also obtained. The tilt of the current change characteristic is gentler than that of the current change characteristic of the gray-scale interpolation voltage in the first embodiment. Therefore, an effect equivalent to or higher than that of the first embodiment is obtained.

The driving method of varying the scan line voltage over three values in the third embodiment is applied not only to the case of switching the scan line voltage from the voltage Von to the voltage Voff at the time of performing gray-scale interpolation within the period of application of the voltage Vofs. Specifically, the scan line voltage may be also switched from the voltage Von to the voltage Voff within the period of application of the gray-scale interpolation voltage Vsig1 at the time of performing the gray-scale interpolation. Also in this case, by varying the scan line voltage over three values and setting the scan line voltage at the time of writing the gray-scale interpolation voltage Vsig1 to the voltage Von2 lower than that at the time of writing the video signal voltage Vsig2, the tilt of the current change characteristic is made sufficiently gentle.

### Fourth Embodiment

### 1. Display Drive Operation

Also in a fourth embodiment, in a manner similar to the first embodiment, in the display device 1 as illustrated in FIGS. 1 and 2, the drive circuit 20 performs display driving on the pixels 11 in the display panel 10 on the basis of the video signal 20A and the synchronization signal 20B. The drive current is injected into the organic EL element 12 in each of the pixels 11, thereby causing light emission. The generated light is taken to the outside and an image is displayed. In the following, the display drive operation in the embodiment will be described in detail.

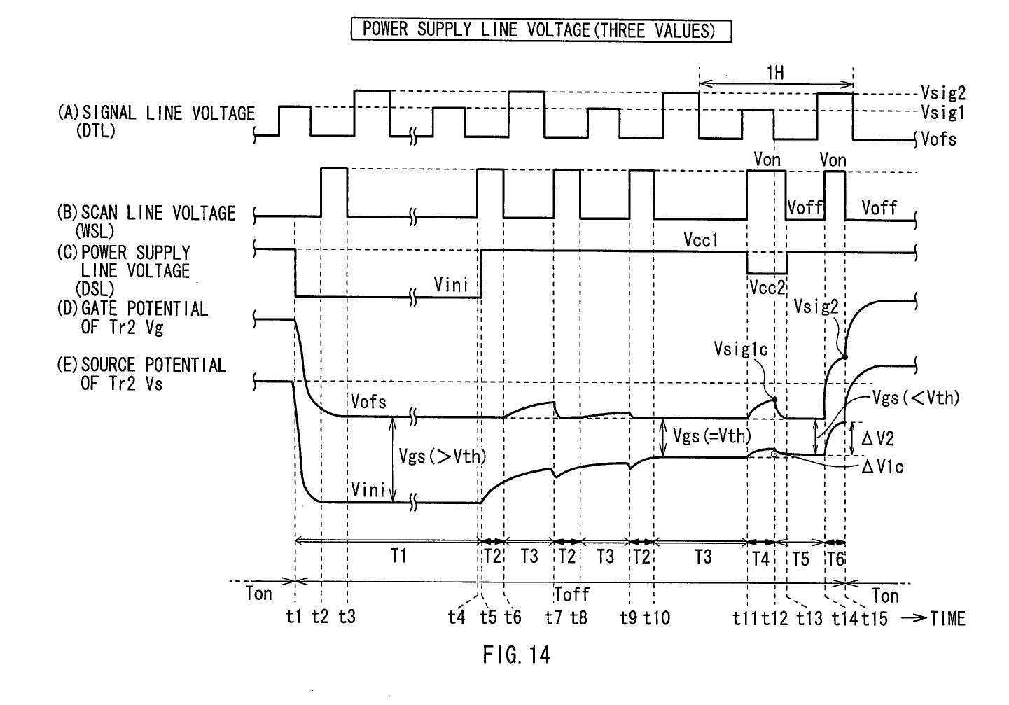

Parts (A) to (E) in FIG. 14 illustrate various timing waveforms of the embodiment. Parts (A), (B), and (C) in FIG. 14 illustrate signal line voltages applied to the signal line DTL, the scan line WSL, and the power supply line DSL, respectively. Parts (D) and (E) in FIG. 14 illustrate the waveforms of the gate potential Vg and the source potential Vs, respectively, in the drive transistor Tr2. Also in the fourth embodiment, like in the first embodiment, a period from timing t1 to timing t15 is a light-off period Toff of the organic EL element 12. The drive circuit 20 performs the display driving in the two-step driving method in the light-off period Toff. Concretely, Vth correction preparation, Vth correction, gray-scale interpolation writing, and video signal writing are performed in this order, and the gray-scale interpolating operation is performed. Among them, with respect to the Vth correction preparation and the Vth correction, operations similar to the first embodiment are performed at similar timings (Vth correction preparation period T1 to Vth correction pause period T3). In the gray-scale interpolation writing period T4, the mobility correction is performed simultaneously with the gray-scale interpolation writing. Also in the video signal writing period T6, the mobility correction is performed simultaneously with the video signal writing.

Further, a period between the gray-scale interpolation writing period T4 and the video signal writing period T6 is the bootstrap suppressing period T5. Specifically, like in the first embodiment, the scan line drive circuit 23 applies the voltage Von to the scan line WSL within the period of applying the gray-scale interpolation voltage Vsig1, and the voltage Von is switched to the voltage Voff within the period of applying the voltage Vofs. In such a manner, in the period from the gray-scale interpolation writing to the video signal writing, the bootstrap operation is suppressed. After the bootstrap suppressing period T5, the video signal voltage Vsig2 is applied and, after that, the period moves to the light-on period Ton.

In the embodiment, the power supply line drive circuit 25 varies the power supply line voltage over three values and outputs the three voltages (Vcc1, Vcc2, and Vini where Vcc1>Vcc2). In the embodiment, the three voltage values (Vsig1 (>Vofs), Vofs, and Vsig2) as signal pulses (signal line voltages), the two voltage values (Von and Voff) as selection pulses (scan line voltages), and the three voltage values (Vcc1, Vcc2, and Vini) as control pulses (power supply line voltages) are output while being switched. The voltages Vcc1 and Vcc2 are voltages for passing the current Id to the drive transistor Tr2 and are set to be a voltage value (constant value) equal to or larger than a voltage value (Vel+Vca) obtained by adding the threshold voltage Vel and the cathode voltage Vca in the organic EL element 12. The voltages Vcc1 and Vcc2 correspond to examples of a “first high power supply voltage” and a “second high power supply voltage”, respectively, in the present invention.

The voltage Vcc1 as higher one of the voltages Vcc1 and Vcc2 is applied to the power supply lines DSL in the Vth correction period T2, the Vth correction pause period T3, the bootstrap suppressing period T5, and the video signal writing period T6. The voltage Vcc2 as lower one is applied to the power supply lines DSL in the gray-scale interpolation writing period T4. In the following, the gray-scale interpolation writing operation and the gray-scale interpolating operation in the embodiment will be described.

Gray-Scale Interpolation Writing Operation

In the embodiment, before start of application of the gray-scale interpolation voltage Vsig1, the power supply line drive circuit 25 decreases the power supply line voltage from the voltage Vcc1 to the voltage Vcc2 (part (C) in FIG. 14). Thereafter, the scan line drive circuit 23 increases the scan line voltage from the voltage Voff to the voltage Von2 at timing t11 when the signal line voltage is equal to the gray-scale interpolation voltage Vsig1 and the power supply line voltage is equal to the voltage Vcc2 (part (B) in FIG. 14). By the operation, the write transistor Tr1 enters the on-state, so that the gate potential Vg rises from the voltage Vofs to the voltage (Vsig1c) corresponding to the signal line voltage at this time (part (D) in FIG. 14). At this stage, like in the first embodiment, the organic EL element 12 is in the cutoff state, so that no current flows in the organic EL element 12. Therefore, the current Id supplied from the drive transistor Tr2 flows in a device capacitor (not illustrated) in the organic EL element 12, and the device capacitor is charged. As a result, the source potential Vs of the drive transistor Tr2 rises only by the potential difference ΔV1c (part (E) in FIG. 14), and the gate-source voltage Vgs becomes (Vsig1+Vth−ΔV1c).

The rise amount of the source potential Vs (the potential difference ΔV1c) becomes larger as the mobility μ of the drive transistor Tr2 becomes higher like in the first embodiment. Therefore, even in the case where the mobility μ varies among the plurality of pixels 11, variations in the current Id (light emission luminance level) caused by the variations in the mobility μ are suppressed.

After application of the gray-scale interpolation voltage Vsig1, the period moves to the bootstrap suppressing period T5, and the bootstrap operation is suppressed (or prevented). Concretely, the scan line drive circuit 23 decreases the scan line voltage from the voltage Von to the voltage Voff at timing t13 when the signal line voltage is equal to the voltage Vofs and the power supply line voltage is equal to the voltage Vcc (part (B) in FIG. 12). By the operation, the write transistor Tr1 is turned off and the writing to the gate of the drive transistor Tr2 is completed.

### 2. Gray-Scale Interpolating Operation

### 2-1. Basic Operation

Next, the gray-scale interpolating operation (gray-scale interpolating operation of the two-step driving method) in the embodiment will be described. In a manner similar to the first embodiment, the signal line drive circuit 24 performs driving on each of the signal lines DTL to vary the voltage value of the gray-scale interpolation voltage Vsig1 over a plurality of voltage values for each of the value (gray-scale level) of the video signal voltage Vsig2. In the gray-scale interpolation writing period T4, the source potential Vs rises, and the rise amount (potential difference ΔV1c) varies according to the voltage value of the gray-scale interpolation voltage Vsig1. The gate potential Vg also increases interlockingly with the rise in the source potential Vs. On the other hand, in the video signal writing period T6, the rise amount of the source potential Vs of the drive transistor Tr2 is the potential difference ΔV2 (constant). Therefore, in a manner similar to the first embodiment, by making the voltage value of the gray-scale interpolation voltage Vsig1 vary with respect to the video signal voltage Vsig2, the gate-source voltage Vgs after application of the video signal is changed. By performing the gray-scale interpolation in the video signal voltage Vsig2 using the voltage values, the larger number of gray-scale levels than the number of output gray-scale levels which is originally set in the signal line drive circuit 24 are expressed.

### 2-2. Bootstrap Suppressing (Preventing) Operation

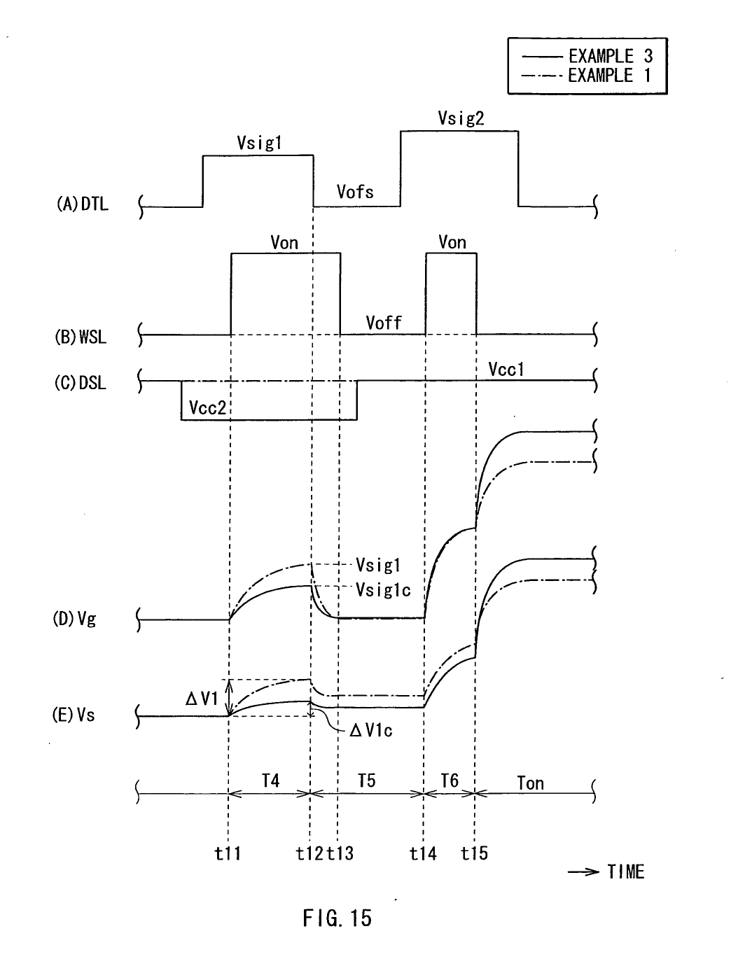

Also in the fourth embodiment, like in the above-described first embodiment, the scan line drive circuit 23 switches the scan line voltage from the voltage Von to the voltage Voff within the period in which the voltage Vofs is applied at the time of the gray-scale interpolation writing. By the operation, the rise in the source potential Vs is suppressed in the bootstrap suppressing period T5 after application of the gray-scale interpolation voltage Vsig1. FIG. 15 illustrates timing waveforms of the display drive operations in the cases of the fourth and first embodiments (Examples 3 and 1). FIG. 15 illustrates, for simplicity, around a portion from timing t11 to timing t15 in the waveforms on part (A) signal line voltage, part (B) scan line voltage, part (C) gate potential Vg, and part (D) source potential Vs. At the time of gray-scale interpolation voltage writing, the rise amount of the source potential Vs in Example 3 in which the voltage Vcc2 lower than the voltage Vcc1 is applied is smaller than that in Example 1 in which the same voltage Vcc1 as that in the case of applying the video signal voltage is applied to the scan lines WSL (ΔV1c<ΔV1). In the bootstrap suppressing period T5, the bootstrap operation is not performed, so that the rise in the source potential Vs is suppressed. As a result, the mobility correction is suppressed (the mobility correction amount becomes smaller) as compared with the foregoing embodiment. In the fourth embodiment, the tilt of the current change characteristic of the gray-scale interpolation voltage Vsig1 is gentler than that in the foregoing embodiment.

### 2-3. Gamma Curve Generating Operation

Also in the fourth embodiment, like in the first embodiment, the current change characteristic of the gray-scale interpolation voltage Vsig1 in the video signal voltage Vsig2 expresses the tendency that as the gray-scale interpolation voltage Vsig1 increases, the current Id decreases, and the tilt is gentle. It is due to the fact that, as described above, in the bootstrap suppressing period T5 after the gray-scale interpolation writing period T4, rise in the source potential Vs is suppressed, and the mobility correction amount decreases. As a result, a change in the current (current to drive the light emitting element) accompanying the rise in the gray-scale interpolation voltage Vsig1 becomes smaller. In other words, the tilt in the current change characteristic of the gray-scale interpolation voltage Vsig1 becomes gentler.

At the time of generating a gamma curve by using the gray-scale interpolation voltage Vsig1 having such a current change characteristic, in a manner similar to the first embodiment, it is sufficient to make the gray-scale interpolation voltage Vsig1 vary over a plurality of voltage values for each value of the video signal voltage Vsig2, and perform gray-scale interpolation in the video signal voltage Vsig2 by using the voltage values. Since the tilt of the current change characteristic of the gray-scale interpolation voltage Vsig1 is gentle, like in the first embodiment, the range of voltage values which are output as the gray-scale interpolation voltage Vsig1 is set to the minimum range.

In the embodiment, the scan line voltage is varied over three values (Vcc1, Vcc2, and Vini). At the time of writing the video signal, the voltage Vcc1 is applied to the scan line WSL. At the time of the gray-scale interpolation writing, the voltage Vcc2 lower than the voltage Vcc1 is applied to the power supply line DSL. In such a manner, the bootstrap operation after performing the gray-scale interpolation is suppressed (prevented). As a result, the mobility correction amount is reduced, and the tilt of the current change characteristic with respect to the gray-scale interpolation voltage Vsig1 is made gentler. Further, in the embodiment, an effect of the bootstrap suppression (the effect of the first embodiment) produced by switching the scan line voltage from the voltage Von to the voltage Voff at the time of the gray-scale interpolation writing within the period of applying the voltage Vofs is also obtained. The tilt of the current change characteristic is gentler than that of the first embodiment. Therefore, an effect equivalent to or higher than that of the first embodiment is obtained.

The driving method of making the power supply line voltage vary over three values in the fourth embodiment is applied not only to the case of switching the scan line voltage from the voltage Von to the voltage Voff at the time of gray-scale interpolation writing within the period of applying the voltage Vofs. Specifically, the scan line voltage may be also switched from the voltage Von to the voltage Voff within the period of applying the gray-scale interpolation voltage Vsig1 at the time of the gray-scale interpolation writing. Also in this case, by varying the power supply line voltage over three values and setting the power supply line voltage at the time of applying the gray-scale interpolation voltage Vsig1 to the voltage Vcc2 lower than that at the time of applying the video signal voltage Vsig2, the tilt of the current change characteristic is made sufficiently gentle.

### Fifth Embodiment

### 1. Display Drive Operation

Also in a fifth embodiment, in a manner similar to the first embodiment, in the display device 1 as illustrated in FIGS. 1 and 2, the drive circuit 20 performs display driving on the pixels 11 in the display panel 10 on the basis of the video signal 20A and the synchronization signal 20B. The drive current is injected into the organic EL element 12 in each of the pixels 11, thereby causing light emission. The generated light is taken to the outside and an image is displayed. Although not illustrated, the period from timing t1 to timing t15 is the light-off period Toff of the organic EL element 12. The drive circuit 20 performs the display driving in the two-step driving method in the light-off period Toff. Concretely, Vth correction preparation, Vth correction, gray-scale interpolation writing, video signal writing, and gray-scale interpolation are performed at timings similar to those of the first embodiment. Specifically, by switching the scan line voltage from the voltage Von to the voltage Voff at the time of the gray-scale interpolation writing within the period of applying the voltage Vofs, the period after the gray-scale interpolation writing before the video signal writing is the bootstrap suppressing period T5. After the bootstrap suppressing period T5, the video signal voltage Vsig2 is applied. Thereafter, the program shifts to the light emission period Ton.

In the fifth embodiment, a signal line drive circuit 24A converts digital input video signals to analog signals which are the gray-scale interpolation voltage Vsig1 and the video signal voltage Vsig2, different from the first embodiment, while making the dynamic range of the gray-scale interpolation voltage Vsig1 smaller than that of the video signal voltage Vsig2. Concretely, such an output is obtained with a circuit configuration described below.

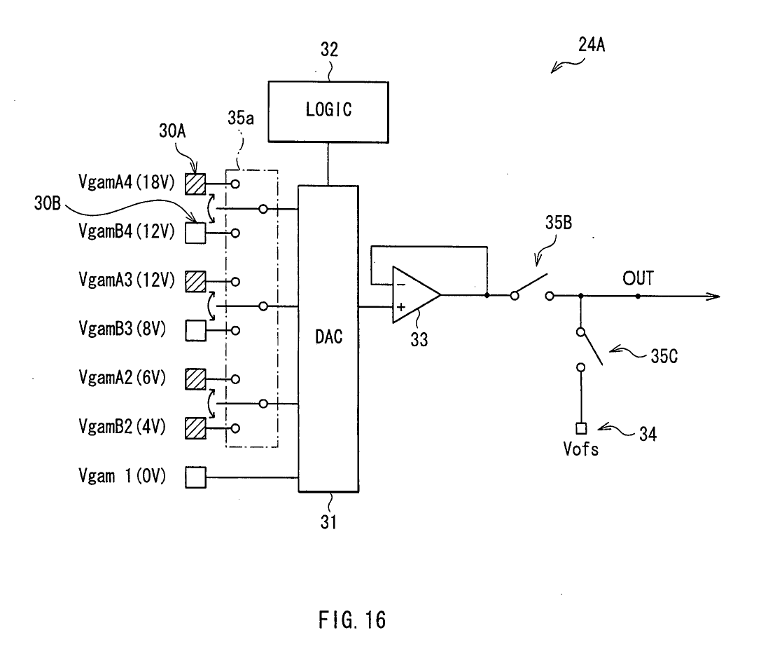

FIG. 16 illustrates a circuit configuration of the signal line drive circuit 24A of the embodiment. The signal line drive circuit 24A has power sources VgamA2 to VgamA4 of the video signal voltage Vsig2, power sources VgamB2 to VgamB4 of the gray-scale interpolation voltage Vsig1, a DAC (Digital/Analog Converter) 31, a logic 32, an operation amplifier 33, and a basic voltage (Vofs) power source 34. In the signal line drive circuit 24A, the power sources VgamA2 to VgamA4 and the power sources VgamB2 to VgamB4 are connected together with a power source Vgam1 (0V) to the DAC 31 via a switch 35A. By switching of the switch 35A, voltage values are selected as VgamA2 (6V) or VgamB2 (4V), VgamA3 (12V) or VgamB3 (8V), and VgamA4 (12V) or VgamB4 (18V). By switching of a switch 35B, the gray-scale interpolation voltage Vsig1 and the video signal voltage Vsig2 are output. By switching of a switch 35C, the voltage Vofs is output.

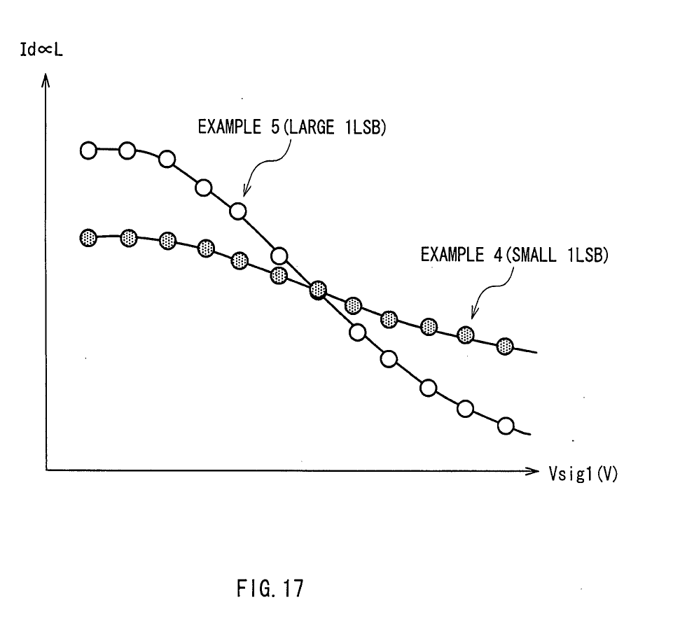

In a manner similar to the first embodiment, the signal line drive circuit 24A performs driving on each of the signal lines DTL to vary the voltage value of the gray-scale interpolation voltage Vsig1 over a plurality of voltage values at each of the voltage values (gray-scale levels) of the video signal voltage Vsig2. By performing the gray-scale interpolation in the video signal voltage Vsig2 using the voltage values, the larger number of gray-scale levels than the number of output gray-scale levels which is originally set in the signal line drive circuit 24A are expressed. At this time, as described above, the signal line drive circuit 24A performs the digital/analog conversion while making the dynamic range of the gray-scale interpolation voltage Vsig1 smaller than that of the video signal voltage Vsig2, so that a current change accompanying the rise in the gray-scale interpolation voltage Vsig1 becomes smaller, and the tilt in the current change characteristic becomes gentle. The tilt in the current change characteristic in the case where the dynamic range of the gray-scale interpolation voltage Vsig1 is small (1LSB is small) is gentler than that in the case where the dynamic range of the gray-scale interpolation voltage Vsig1 is large (FIG. 17).

At the time of generating a gamma curve by using the gray-scale interpolation voltage Vsig1, in a manner similar to the first embodiment, it is sufficient to make the gray-scale interpolation voltage Vsig1 vary over a plurality of voltage values for each value of the video signal voltage Vsig2, and perform gray-scale interpolation in the video signal voltage Vsig2 by using the voltage values. Since the tilt of the current change characteristic of the gray-scale interpolation voltage Vsig1 is gentle, like in the first embodiment, the range of voltage values which are output as the gray-scale interpolation voltage Vsig1 is set to the minimum range.

In the embodiment as described above, at the time of converting digital input video signals to analog signals as the gray-scale interpolation voltage Vsig1 and the video signal voltage Vsig2, the signals are output while making the dynamic range of the gray-scale interpolation voltage Vsig1 smaller than that of the video signal voltage Vsig2. By the operation, the tilt of the current change characteristic with respect to the gray-scale interpolation voltage Vsig1 is made gentle. Further, in the embodiment, the effect of the bootstrap suppression produced by switching the scan line voltage from the voltage Von to the voltage Voff at the time of the gray-scale interpolation writing within the period of applying the voltage Vofs (the effect in the first embodiment) is also obtained. The tilt of the current change characteristic is made gentler than that of the first embodiment. Therefore, an effect equivalent to or higher than that of the first embodiment is obtained.

The driving method by adjusting the dynamic range of the gray-scale interpolation voltage and the video signal voltage in the fifth embodiment is applied not only to the case of switching the scan line voltage from the voltage Von to the voltage Voff at the time of the gray-scale interpolation writing within the period of applying the voltage Vofs. Specifically, the scan line voltage may be also switched from the voltage Von to the voltage Voff within the period of applying the gray-scale interpolation voltage Vsig1 at the time of the gray-scale interpolation writing. Also in this case, by making the dynamic range of the gray-scale interpolation voltage smaller than that of the video signal voltage, the tilt of the current change characteristic is made sufficiently gentle.

### Module and Application Examples

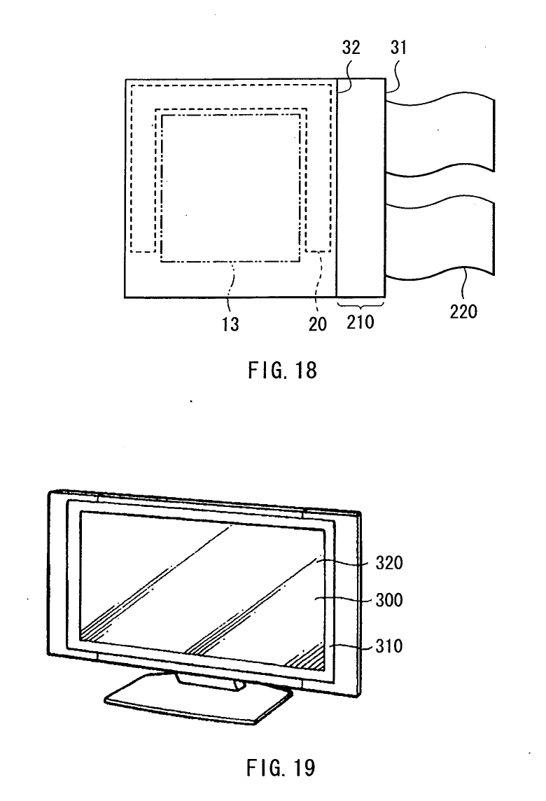

Referring to FIGS. 18 to 23, application examples of the display device 1 described in the foregoing embodiments will be described below. The display device 1 of the embodiments are applicable to electronic unit in all of fields such as a television apparatus, a digital camera, a notebook-sized personal computer, a portable terminal device such as a cellular phone, a video camera, or the like. In other words, the display device 1 is applicable to electronic devices in all of fields, which display a video signal input from the outside or a video signal generated on the inside as an image or a video image.

Module

The display device 1 is assembled as, for example, a module as illustrated in FIG. 18, in various electronic devices such as application examples 1 to 5 which will be described later. The module is obtained by, for example, providing a region 210 exposed from a sealing substrate 32 in one side of a substrate 31 and forming external connection terminals (not illustrated) by extending wires of the drive circuit 20 in the exposed region 210. The external connection terminals may be provided with flexible printed circuits (FPCs) 220 for inputting/outputting signals.

### Application Example 1

FIG. 19 illustrates the appearance of a television apparatus. The television apparatus has, for example, a video display screen unit 300 including a front panel 310 and a filter glass 320. The display device 1 is assembled in the video display screen unit 300.

### Application Example 2

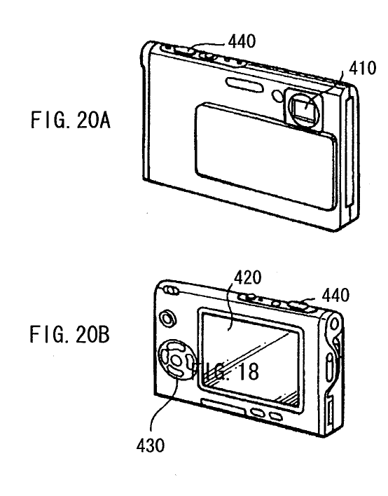

FIGS. 20A and 20B illustrate the appearance of a digital camera. The digital camera has, for example, a light emitting unit 410 for flash, a display unit 420, a menu switch 430, and a shutter button 440. In the display unit 420, the display device 1 is assembled.

### Application Example 3

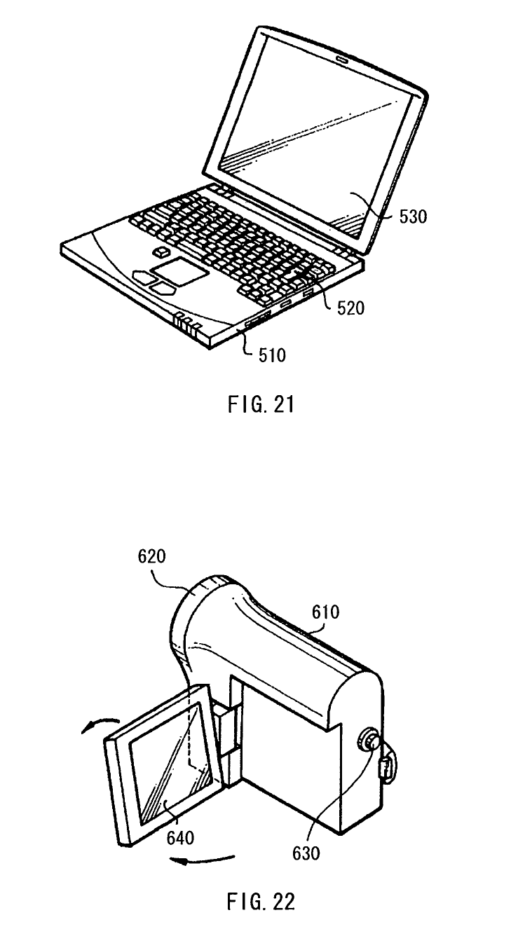

FIG. 21 illustrates the appearance of a notebook-sized personal computer. The notebook-sized personal computer has, for example, a body 510, a keyboard 520 for operation of inputting characters and the like, and a display unit 530 for displaying an image. In the display unit 530, the display device 1 is assembled.

### Application Example 4

FIG. 22 illustrates the appearance of a video camera. The video camera has, for example, a body 610, a lens 620 for capturing an object, provided in the front face of the body 610, a shooting start/stop switch 630, and a display unit 640. In the display unit 640, the display device 1 is assembled.

### Application Example 5

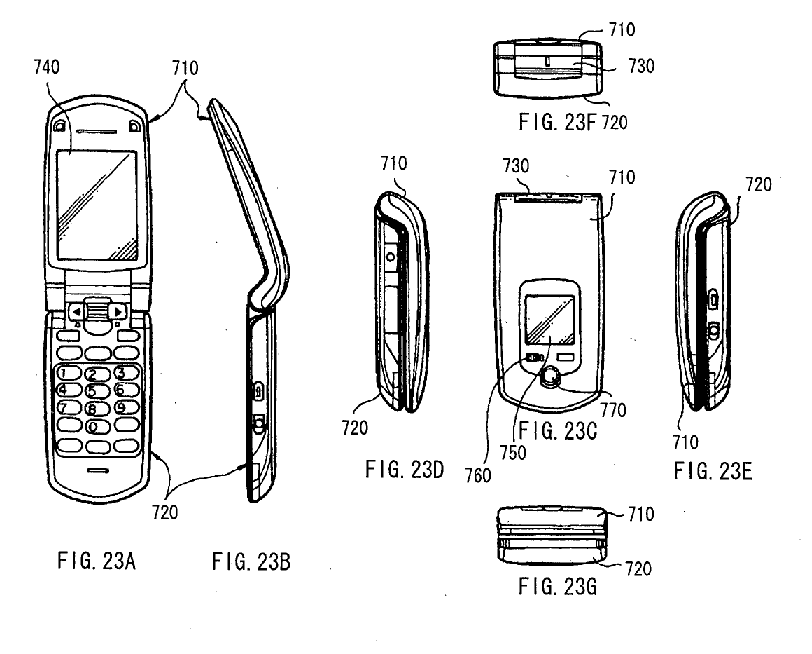

FIGS. 23A to 23G illustrate the appearance of a cellular phone. The cellular phone is constructed by, for example, coupling an upper casing 710 and a lower casing 720 by a coupling part (hinge) 730 and has a display 740, a sub-display 750, a picture light 760, and a camera 770. In the display 740 or the sub-display 750, the display device 1 is assembled.

Although the present invention has been described above by the embodiments and the application examples, the present invention is not limited to the embodiments and the like but may be variously modified. For example, in the foregoing embodiments and the like, the case of expressing 10-bit gray-scale in the light emission luminance level L by performing the 8-bit gray-scale interpolation which is provided by the video signal 20A with two bits by the gray-scale interpolating operation has been mainly described. However, the invention is not limited to the case. For example, by performing 6-bit gray-scale interpolation with four bits, the 10-bit gray-scale expression is realized. By performing 10-bit gray-scale interpolation with two bits, the 12-bit gray-scale expression may be realized. In the case of interpolating a video signal which is originally set to the m-bit gray-scale with n bits, it is sufficient to make the gray-scale interpolation voltage Vsig1 change to 2ⁿ values.

Although the case where the display device 1 is of the active matrix type has been described in the foregoing embodiments and the like, the circuit configuration of the pixel 11 for active matrix driving is not limited to that described in the foregoing embodiments and the like. Specifically, a capacitor, a transistor, or the like may be provided in the pixel 11 as necessary.

Further, in the embodiments and the like, although the case that the driving operations of the scan line drive circuit 23, the signal line drive circuit 24, and the power supply line drive circuit 25 are controlled by the timing generating circuit 22 has been described, another circuit may control the driving operations. The scan line drive circuit 23, the signal line drive circuit 24, and the power supply line drive circuit 25 may be controlled by hardware (circuit) or software (program).

In addition, although the case where the pixel 11 has the circuit configuration of so-called “2Tr1C” has been described in the foregoing embodiments and the like, the circuit configuration of the pixel 11 is not limited to 2Tr1C. In other words, as long as a circuit configuration that a transistor is connected in series to the organic EL element 12 is included, the pixel 11 may have a circuit configuration other than “2Tr1C”.

The present application contains subject matter related to that disclosed in Japanese Priority Patent Application JP 2009-258317 filed in the Japan Patent Office on Nov. 11, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a plurality of pixels each including a light emitting element;
scan lines, signal lines, and power supply lines, each line being connected to some of the plurality of pixels;
a scan line drive circuit applying a selection pulse to each of the scan lines in succession, the selection pulse allowing a row of pixels to be selected from the plurality of pixels;
a signal line drive circuit applying a signal pulse to each of the signal lines through switching a gray-scale interpolation voltage, a basic voltage and an originally provided video signal voltage, in this order, and varying the gray-scale interpolation voltage over a plurality of voltage values, thereby performing gray-scale interpolation on a light emission luminance level for each of the light emitting elements; and
a power supply line drive circuit applying a control pulse to each of the power supply lines, the control pulse allowing the light emitting element to be on and off,
wherein the scan line drive circuit generates the selection pulse through alternately switching an on-voltage and an off-voltage, and applies the generated selection pulse to each of the scan lines so that application of the on-voltage to the scan line starts in a time period of the gray-scale interpolation voltage and the on-voltage is switched to the off-voltage in a time period of the basic voltage.

2. The display device according to claim 1, wherein the gray-scale interpolation voltage is lower than the basic voltage.

3. The display device according to claim 1, wherein the scan line drive circuit performs a control so that,
the selection pulse rises up from the off-voltage to a first on-voltage and then falls down from the first on-voltage to the off-voltage, in a time period of the video signal voltage, and
the selection pulse rises up from the off-voltage to a second on-voltage, which is lower than the first on-voltage, in a time period of the gray-scale interpolation voltage, and then falls down from the second on-voltage to the off-voltage in a time period of the basic voltage.

4. The display device according to claim 1, wherein the control pulse is generated through alternately switching a higher power supply voltage and a lower power supply voltage,
a first voltage and a second voltage are provided as the higher power supply voltage, and
the first voltage is applied to the power supply line during application of the video signal voltage, and the second voltage, which is lower than the first voltage, is applied to the power supply line during application of the gray-scale interpolation voltage.

5. The display device according to claim 1, wherein
an input video signal which is a digital signal is converted into the gray-scale interpolation voltage and the video signal voltage which are analog signals, in such a manner that a dynamic range of the gray-scale interpolation voltage is narrower than that of the video signal voltage.

6. A display device comprising:
a plurality of pixels each including a light emitting element;
scan lines, signal lines, and power supply lines, each line being connected to some of the plurality of pixels;
a scan line drive circuit applying a selection pulse to each of the scan lines in succession, the selection pulse allowing a row of pixels to be selected from the plurality of pixels;
a signal line drive circuit applying a signal pulse to each of the signal lines through switching a gray-scale interpolation voltage, a basic voltage and an originally provided video signal voltage, in this order, and varying the gray-scale interpolation voltage over a plurality of voltage values, thereby performing gray-scale interpolation on a light emission luminance level for each of the light emitting elements; and
a power supply line drive circuit applying a control pulse to each of the power supply lines, the control pulse allowing the light emitting element to be on and off,
wherein the scan line drive circuit generates the selection pulse through alternately switching an on-voltage and an off-voltage, and applies the generated selection pulse to each of the scan lines, and
the scan line drive circuit performs a control so that,
the selection pulse rises up from the off-voltage to a first on-voltage and then falls down from the first on-voltage to the off-voltage, in a time period of the video signal voltage, and
the selection pulse rises up from the off-voltage to a second on-voltage, which is lower than the first on-voltage, in a time period of the gray-scale interpolation voltage, and then falls down from the second on-voltage to the off-voltage in a time period of the basic voltage.

7. A display device comprising:
a plurality of pixels each including a light emitting element;
scan lines, signal lines, and power supply lines, each line being connected to some of the plurality of pixels;
a scan line drive circuit applying a selection pulse to each of the scan lines in succession, the selection pulse allowing a row of pixels to be selected from the plurality of pixels;
a signal line drive circuit applying a signal pulse to each of the signal lines through switching a gray-scale interpolation voltage, a basic voltage and an originally provided video signal voltage, in this order, and varying the gray-scale interpolation voltage over a plurality of voltage values, thereby performing gray-scale interpolation on a light emission luminance level for each of the light emitting elements; and
a power supply line drive circuit applying a control pulse to each of the power supply lines, the control pulse allowing the light emitting element to be on and off,
wherein the application of the control pulse to each of the power supply lines is accomplished through alternately switching a higher power supply voltage and a lower power supply voltage, and through applying the switched power supply voltage to the power supply line, and
a first higher power supply voltage is applied to the power supply line during application of the video signal voltage, and a second higher power supply voltage, which is lower than the first higher power supply voltage, is applied to the power supply line during application of the gray-scale interpolation voltage.

8. A display device comprising:
a plurality of pixels each including a light emitting element;
scan lines, signal lines, and power supply lines, each line being connected to some of the plurality of pixels;
a scan line drive circuit applying a selection pulse to each of the scan lines in succession, the selection pulse allowing a row of pixels to be selected from the plurality of pixels;
a signal line drive circuit applying a signal pulse to each of the signal lines through switching a gray-scale interpolation voltage, a basic voltage and an originally provided video signal voltage, in this order, and varying the gray-scale interpolation voltage over a plurality of voltage values, thereby performing gray-scale interpolation on a light emission luminance level for each of the light emitting elements; and
a power supply line drive circuit applying a control pulse to each of the power supply lines, the control pulse allowing the light emitting element to be on and off,
wherein an input video signal which is a digital signal is converted into the gray-scale interpolation voltage and the video signal voltage which are analog signals, in such a manner that a dynamic range of the gray-scale interpolation voltage is narrower than that of the video signal voltage.

9. The display device according to any one of claims 1 to 8, wherein the pixel includes an organic electric field light emitting element as the light emitting element, first and second transistors each having a gate, a source and a drain, and a retention capacitor, the organic electric field light emitting element having an anode and a cathode, the gate of the first transistor being connected to the scan line, one of the drain and the source in the first transistor being connected to the signal line, whereas the other one thereof being connected to both the gate of the second transistor and one end of the retention capacitor, one of the drain and the source in the second transistor being connected to the power supply line, whereas the other one thereof being connected to both the other end of the retention capacitor and the anode of the light emitting element, and the cathode of the light emitting element being set to a fixed potential.

10. A method of driving a display device, comprising steps of:
at the time of performing display driving on a plurality of pixels each including a light emitting element and to which scan lines, signal lines, and power supply lines are connected,
applying a selection pulse to each of the scan lines in succession, the selection pulse allowing a row of pixels to be selected from the plurality of pixels;
applying a signal pulse to each of the signal lines through switching a gray-scale interpolation voltage, a basic voltage and an originally provided video signal voltage, in this order;
applying a control pulse to each of the power supply lines, the control pulse allowing the light emitting element to be on and off;
varying the gray-scale interpolation voltage over a plurality of voltage values, thereby performing gray-scale interpolation on a light emission luminance level for each of the light emitting elements; and
generating the selection pulse through alternately switching an on-voltage and an off-voltage, and applying the generated selection pulse to each of the scan lines so that application of the on-voltage to the scan line starts in a time period of the gray-scale interpolation voltage and the on-voltage is switched to the off-voltage in a time period of the basic voltage.

11. The method of driving a display device according to claim 10, wherein the gray-scale interpolation voltage is lower than the basic voltage.

12. A method of driving a display device, comprising steps of:
at the time of performing display driving on a plurality of pixels each including a light emitting element and to which scan lines, signal lines, and power supply lines are connected,
applying a selection pulse to each of the scan lines in succession, the selection pulse allowing a row of pixels to be selected from the plurality of pixels;
applying a signal pulse to each of the signal lines through switching a gray-scale interpolation voltage, a basic voltage and an originally provided video signal voltage, in this order;
applying a control pulse to each of the power supply lines, the control pulse allowing the light emitting element to be on and off;
varying the gray-scale interpolation voltage over a plurality of voltage values, thereby performing gray-scale interpolation on a light emission luminance level for each of the light emitting elements; and
performing a control so that,
the selection pulse rises up from the off-voltage to a first on-voltage and then falls down from the first on-voltage to the off-voltage, in a time period of the video signal voltage, and the selection pulse rises up from the off-voltage to a second on-voltage, which is lower than the first on-voltage, in a time period of the gray-scale interpolation voltage, and then falls down from the second on-voltage to the off-voltage in a time period of the basic voltage

13. A method of driving a display device, comprising the steps of:
at the time of performing display driving on a plurality of pixels each including a light emitting element and to which scan lines, signal lines, and power supply lines are connected,
applying a selection pulse to each of the scan lines in succession, the selection pulse allowing a row of pixels to be selected from the plurality of pixels;
applying a signal pulse to each of the signal lines through switching a gray-scale interpolation voltage, a basic voltage and an originally provided video signal voltage, in this order;
applying a control pulse to each of the power supply lines, the control pulse allowing the light emitting element to be on and off;
varying the gray-scale interpolation voltage over a plurality of voltage values, thereby performing gray-scale interpolation on a light emission luminance level for each of the light emitting elements; and
applying the control pulse to each of the power supply lines through alternately switching a higher power supply voltage and a lower power supply voltage, and through applying the switched power supply voltage to the power supply line, the higher power supply voltage including a first voltage and a second voltage lower than the first voltage, and applying the first voltage to the power supply line during application of the video signal voltage, and applying the second voltage to the power supply line during application of the gray-scale interpolation voltage.

14. A method of driving a display device, comprising the steps of:
at the time of performing display driving on a plurality of pixels each including a light emitting element and to which scan lines, signal lines, and power supply lines are connected,
applying a selection pulse to each of the scan lines in succession, the selection pulse allowing a row of pixels to be selected from the plurality of pixels;
applying a signal pulse to each of the signal lines through switching a gray-scale interpolation voltage, a basic voltage and an originally provided video signal voltage, in this order;
applying a control pulse to each of the power supply lines, the control pulse allowing the light emitting element to be on and off;
varying the gray-scale interpolation voltage over a plurality of voltage values, thereby performing gray-scale interpolation on a light emission luminance level for each of the light emitting elements; and
converting an input video signal which is a digital signal into the gray-scale interpolation voltage and the video signal voltage which are analog signals, in such a manner that a dynamic range of the gray-scale interpolation voltage is narrower than that of the video signal voltage.

15. Electronic unit having the display device according to any one of claims 1 to 8.
